(19) United States
(12) Patent Application Publication
(10) Pub. No.: US 2006/0173772 A1
(43) Pub. Date: Aug. 3, 2006

(54) Systems and methods for automated processing, handling, and facilitating a trade credit transaction

(76) Inventors: John B. Hayes, Atlanta, GA (US); John Chandy, Buford, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/049,919

(22) Filed: Feb. 2, 2005

(51) Int. Cl. G06Q 40/00

(52) U.S. Cl. 705/37

(57) ABSTRACT

The present invention relates to methods and systems for automated processing, handling, and facilitating a trade credit transaction. One embodiment of the invention can comprise an automated trade credit processing application engine. The automated trade credit processing application engine can be adapted to approve a customer for a purchase using trade credit, and cause an invoice associated with the purchase to be assigned to a customer sponsor. The automated trade credit processing application engine can be further adapted to determine an advance for a seller sponsor to pay to a seller associated with the purchase, wherein the customer sponsor can guarantee payment of some or all of the invoice to the seller sponsor. Moreover, the automated trade credit processing application engine can be adapted to determine an allocation for the payment, wherein the allocation can be applied by the seller sponsor to an account associated with the seller, after a customer sponsor makes a payment against the invoice to the seller sponsor.

### FIELD OF THE INVENTION

The invention is generally directed to systems and methods for processing a credit transaction. More particularly, the invention relates to systems and methods for automated processing, handling, and facilitating a trade credit transaction.

### BACKGROUND

Fifty years ago, it was a common practice for most businesses to grant credit to their customers to encourage sales. The practice was common in retailing to afford the customer the instant gratification of receiving the goods while delaying the payment, even if only until the end of the month. The practice of granting credit in business to business transactions exists for even more practical reasons—it is the accepted trade practice, the buyer wants an opportunity to inspect the goods, or the buyer may need the extra time to pay to increase the buyer's working capital.

While the granting of credit to customers may be necessary or beneficial, it carries numerous risks and burdens to the business such as: (1) the burden of maintaining an accounts receivable system for tracking what is owed, (2) receiving payment and matching the payment to the debtor and the transaction, (3) collecting unpaid accounts; (4) the risk of not being paid; and (5) the delay in receiving the funds.

Retailers, large and small, endured the considerable risk and burden of carrying the credit of their customers on the belief that it was necessary to maintain or increase sales. As consumers and the financial services industry embraced credit transactions, a number of “credit bureaus” were created in the United States to assist retailers in making credit decisions and collections.

Banks soon recognized that they had considerable expertise in managing the credit process and began offering large retailers the opportunity to outsource the risk and burden of extending credit to the consumer customers, frequently with a private-labeled program that did not identify the bank as the creditor on the “charge-a-plate” that carried the retailer's name. This approach worked well for large retailers, but did nothing to help the small retailer.

In 1958, Bank of America created a program that allowed the small retailer to accept the “BankAmericard” and know that payment for an approved charge would be paid by the bank (provided the charge was legitimate and there was no dispute with the customer about the purchase). American Express created its charge card the same year. The BankAmericard network became Visa as more banks joined the network. MasterCard was created by another network of banks (the Interbank Card Association) in 1966.

The bank-issued credit cards facilitated transactions through centralized networks due to the parallel growth of information technology and analytics. In the global credit card system, the credit risk of the account debtor (the consumer customer) is carried by the card issuer, while the risk of fraud and disputes remains with the merchant (the retailer) and the bank providing the merchant account. Information technology allowed the merchant's bank and the card issuer's bank not only to automatically process the transactions, but to develop automated methods of detecting fraud on the part of both the card holder and the merchant.

While the credit card and its companion system, the debit card, have become an acceptable or preferred method for retailers to provide credit to consumers, each offers little assistance to a significant number of businesses that sell to other businesses. Whether a law firm billing business customers, a manufacturer selling to a retailer, or a staffing agency providing medical personnel to a hospital, many businesses find it necessary to grant credit to their business customers to maintain or grow their sales, and the requirement for payment by credit card would not be an acceptable trade practice.

Relatively larger companies have long been able to outsource the burden and risk of granting credit to their customers through a process called “factoring.” Factoring is different from “receivable discounting,” described below, in that a party, the factor, purchases the invoice “without recourse” to the seller in the event the account debtor does not pay. Factors can provide a valuable service, but that service is generally limited to larger companies. There are a number of factors in the United States that can assume the processing, collections, and credit protection burdens on behalf of business customers. These factors include, among others, The CIT Group, Inc.; GMAC, a unit of General Motors; SunTrust Factors, a unit of SunTrust Bank; Capital Factors, a unit of Union Planters Bank.

In true factoring, the factor assumes the (1) burden of processing the accounts receivable, which includes operating a lock box, matching payments to invoices, and reconciling the accounts, (2) collecting past due accounts, and (3) assuming the credit risk of the account debtor. The factor can charge a fee for these services, frequently at a cost lower than a single company can perform the same functions internally. In some instances, the factor can advance a portion of the accounts to the seller, charging the seller interest on that advance until the account is paid by the account debtor.

In some cases, the advance to the seller can be made by the seller's bank, and the amounts collected by the factor and the credit protection can be assigned to the bank. This “bank participation” factoring has traditionally been negotiated on an individual basis between the business customer, the factor, and the bank. Historically, bank participation factoring required the bank to establish some method for monitoring collateral associated with the seller.

At the other end of the spectrum are “receivables discounters” in which a “lender” (usually an independent, unregulated finance company) lends to the business a percentage of the face amount of an invoice for a very high interest rate. Receivables discounters typically purchase trade receivables from business sellers, frequently at a steep discount and with recourse to the seller if the trade buyer fails to pay. Receivables discounters can avoid state usury laws by “discounting” the invoice, rather than calling the charge “interest.” While many of these receivables discounters call themselves “factors,” they are not offering the shifting of risk and cost offered by a true factor. Instead, the lender is assuming no credit risk on the account debtor and generally does not provide the service of collections, application of payment, or account reconciliation. Furthermore, these receivables discounters are generally not true factors since the invoices they purport to “purchase” are “full recourse” back to the seller in the event the account debtor does not pay.

The effective interest charged by receivables discounters, which can frequently exceed 30%, can oftentimes be significantly higher than the interest and fees typically charged by a true factor, and the borrower does not obtain the cost and risk reductions available through true factoring. Yet, many small businesses have no other choice to obtain working capital than to use these lenders with disadvantageous costs and burdens.

One conventional solution offered to some banks provides a software package enabling banks to process accounts receivable of borrowers for a fee. This solution can improve borrowers' collaterals since the banks can better control the receivables processing. Even though this solution is less expensive than many receivables discounters, this solution still has many drawbacks including the lack of credit protection coverage for the payment of account debtors, the lack of processing the lock box, no payment matching, no account reconciliation, and no collections processing.

Therefore a need exists for systems and methods for automating processing, handling, and facilitating a trade credit transaction.

### SUMMARY OF THE INVENTION

Accordingly, systems and processes according to various aspects and embodiments according to the invention address at least some or all of these issues and combinations of them. They do so at least in part by automating processing, handling, and facilitating trade credit transactions for entities such as businesses.

The present invention automates the processing, handling, and facilitating of trade credit transactions for businesses, benefiting both banks and their customers such as businesses, governments, or other organizations. Customers such as businesses, governments, or other organizations can receive the advantages of extended payment, while the banks can receive the advantages of highly secure and liquid collateral. In particular, the present invention can open the trade credit industry to relatively small businesses that sell to other businesses, governments, or other organizations. The use of trade credit by small businesses can provide the immediate advantage of outsourcing the burden and risk of extending credit to their customers. Businesses utilizing trade credit can increase their cash flow by receiving payment at the time of invoicing, receiving guaranteed payments for the amount of the invoice, increasing sales volume and profit margins, profitably reducing inventory levels of goods for sale, permitting sales to new customers while minimizing the risk to the business, and increasing sales to new industries and markets by permitting new or extended payment terms to customers.

The present invention also provides user interfaces for a user to track, monitor, and review data associated with a trade credit transaction. In particular, a user such as a seller sponsor or bank can view a trade credit transaction in a double entry accounting-type format from the particular point of view of the user. Tracking, monitoring, and reviewing data associated with a trade credit transaction using the user interfaces can provide visibility and transparency of the trade credit transaction for users of the invention. Reports for users can be generated from the user interfaces, permitting users to disseminate information to others, such as an auditor, and to store records for subsequent retrieval.

As defined and used within this specification, a “business entity” refers to a group, organization, government, government agency or office, or business organized for profit or non-profit.

A “financial entity” refers to a bank, savings and loan, credit union, community bank, an issuing bank, a merchant bank, or an acquiring bank.

An “interchange” refers to a financial entity, a cooperative venture owned by other financial entities, or an entity that administers a electronic transaction system and network.

Further, as defined and used within this specification, “trade credit” refers to credit extended to a business entity (a buyer or customer) for the purchase of goods, services, and/or intangibles from another business entity (a seller).

Furthermore, as defined and used within this specification, “trade credit transaction” refers to a sale of a good, service, and/or intangible by one business entity (a seller) to another business entity (a buyer or customer) using trade credit.

As defined and used within this specification, a “customer sponsor” can be any entity, such as a financial institution or bank, which issues trade credit to a customer and sponsors that customer in a trade credit transaction. The customer sponsor can guarantee any payments owed for purchases of goods, services, and/or intangibles by the customer using the trade credit. If the customer fails to make a payment, the customer sponsor can assume responsibility for making payment on behalf of the customer.

As defined and used within this specification, a “customer sponsor” can any entity, such as a financial institution or bank, which administers an account for a seller and sponsors that seller in a trade credit transaction. The seller sponsor can assume responsibility for advancing money to the seller for a purchase from the seller using trade credit, and can also guarantee the sale of goods, services, and/or intangibles by the seller.

One aspect of systems and processes according to various embodiments of the invention, focuses on a computer-implemented method for automating processing of a trade credit transaction between a seller and a customer. The method can provide an automated trade credit transaction processing program on a computer system. The automated trade credit transaction processing program is capable of approving a customer for a purchase using trade credit.

The program is further capable of causing an invoice associated with the purchase to be assigned to a customer sponsor. In addition, the program is capable of determining an advance for a seller sponsor to pay to a seller associated with the purchase, wherein the customer sponsor can guarantee payment of some or all of the invoice to the seller sponsor. The program is also capable of after a customer sponsor makes a payment against the invoice to the seller sponsor, determining an allocation for the payment, wherein the allocation can be applied by the seller sponsor to an account associated with the seller.

Another aspect of systems and processes according to various embodiments of the invention, focuses on a computer-implemented method for using trade credit to facilitate a purchase for a customer. The method can provide an automated trade credit transaction processing program on a computer system. The automated trade credit transaction processing program is capable of requesting approval of a purchase using trade credit. The program is further capable of receiving approval or denial of the purchase using trade credit. In addition, the program is capable of assigning an invoice associated with the purchase to a customer sponsor, wherein the customer sponsor can guarantee payment of some or all of the invoice to a seller sponsor, and the customer sponsor can receive a payment from the customer for the purchase. The program is also capable of receiving an advance from a seller sponsor for the purchase.

Yet another aspect of systems and processes according to various embodiments of the invention, focuses on a computer-implemented method for using trade credit to facilitate a purchase from a seller. The method can provide an automated trade credit transaction processing program on a computer system. The program is capable of requesting a trade credit transaction from a seller. In addition, the program is capable of receiving a good or service in a purchase associated with the trade credit transaction. The program is further capable of receiving a notification from a customer sponsor to pay for the purchase, wherein the customer sponsor can be assigned an invoice associated with the purchase, and the customer sponsor can guarantee a payment of the invoice to a seller sponsor. The program is also capable of transmitting a payment for the purchase to the customer sponsor.

Another aspect of systems and processes according to various embodiments of the invention, focuses on a computer-implemented method for processing a trade credit transaction. The method can provide an automated trade credit transaction processing program on a computer system. The program is capable of receiving assignment of an invoice associated with a purchase made by a customer using trade credit, wherein payment of the invoice is guaranteed to a seller sponsor. The program is further capable of notifying the customer of a payment term associated with the purchase. In addition to, the program is capable of paying a seller sponsor some or all of an amount associated with the invoice.

Yet another aspect of systems and processes according to various embodiments of the invention, focuses on a computer-implemented method for processing a trade credit transaction. The method can provide an automated trade credit transaction processing program on a computer system. The program is capable of paying an advance to a seller, wherein the advance is associated with a purchase from the seller. In addition, the program is capable of receiving a payment from a customer sponsor, wherein the payment is associated with an invoice assigned to the customer sponsor by the seller. The program is also capable of allocating the payment to at least one account associated with the seller.

Another aspect of systems and processes according to various embodiments of the invention, focuses on a system for using trade credit to facilitate a purchase for a customer. The system can include an automated trade credit processing application engine. The engine is adapted to approve a customer for a purchase using trade credit. In addition, the engine is adapted to cause an invoice associated with the purchase to be assigned to a customer sponsor. The engine is also adapted to determine an advance for a seller sponsor to pay to a seller associated with the purchase, wherein the customer sponsor can guarantee payment of some or all of the invoice to the seller sponsor. The engine is also adapted to after a customer sponsor makes a payment against the invoice to the seller sponsor, determine an allocation for the payment, wherein the allocation can be applied by the seller sponsor to an account associated with the seller.

Yet another aspect of systems and processes according to various embodiments of the invention, focuses on a system for using trade credit to facilitate a purchase from a seller. The system can include an automated trade credit processing application engine. The engine is adapted to request approval of a purchase using trade credit. In addition, the engine is adapted to receive approval or denial of the purchase using trade credit. The engine is further adapted to assign an invoice associated with the purchase to a customer sponsor, wherein the customer sponsor can guarantee payment of some or all of the invoice to a seller sponsor, and the customer sponsor can receive a payment from the customer for the purchase. The engine is also adapted to receive an advance from a seller sponsor for the purchase.

Another aspect of systems and processes according to various embodiments of the invention, focuses on a system for processing a trade credit transaction. The system can include an automated trade credit processing application engine. The engine is adapted to request a trade credit transaction from a seller. In addition, the engine is adapted to receive a good or service in a purchase associated with the trade credit transaction. Moreover, the engine is adapted to receive a notification from a customer sponsor to pay for the purchase, wherein the customer sponsor can be assigned an invoice associated with the purchase, and the customer sponsor can guarantee a payment of the invoice to a seller sponsor. The engine is also adapted to transmit a payment for the purchase to the customer sponsor.

Yet another aspect of systems and processes according to various embodiments of the invention, focuses on a system for processing a trade credit transaction. The system can include an automated trade credit processing application engine. The engine is adapted to receive assignment of an invoice associated with a purchase made by a customer using trade credit, wherein payment of the invoice is guaranteed to a seller sponsor. In addition, the engine is adapted to notify the customer of a payment term associated with the purchase. The engine is also adapted to pay a seller sponsor some or all of an amount associated with the invoice.

Another aspect of systems and processes according to various embodiments of the invention, focuses on a system for processing a trade credit transaction. The system can include an automated trade credit processing application engine. The engine is adapted to pay an advance to a seller, wherein the advance is associated with a purchase from the seller. In addition, the engine is adapted to receive a payment from a customer sponsor, wherein the payment is associated with an invoice assigned to the customer sponsor by the seller. The engine is also adapted to allocate the payment to at least one account associated with the seller.

These example embodiments are mentioned not to limit or define the invention, but to provide examples of embodiments of the invention to aid understanding thereof. Example embodiments are discussed in the Detailed Description, and further description of the invention is provided there.

Objects, features and advantages of various systems and processes according to various embodiments of the present invention can include:

(1) Providing systems and methods for processing, handling, and facilitating a trade credit transaction;

(2) Providing systems and methods for automatically processing, handling, and facilitating a trade credit transaction;

(3) Providing systems and methods for automating processing of a trade credit transaction between a seller and a customer;

(4) Providing systems and methods for using trade credit to facilitate a purchase for a customer;

(5) Providing systems and methods for using trade credit to facilitate a purchase from a seller;

(6) Providing systems and methods for processing a trade credit transaction;

(7) Providing systems and methods for providing a user interface for automatically processing, handling, and facilitating a trade credit transaction;

(8) Providing systems and methods for providing a user interface for tracking, monitoring, and reviewing data associated with a trade credit transaction;

(9) Providing systems and methods for utilizing at least one lending rule to facilitate a trade credit transaction;

(10) Providing systems and methods for utilizing at least one credit rule to facilitate a trade credit transaction; and

(11) Providing systems and methods for utilizing at least one fraud detection device to facilitate a trade credit transaction.

Other objects, features and advantages will become apparent with respect to the remainder of this document.

### BRIEF DESCRIPTION OF THE DRAWINGS

These and other features, aspects, and advantages of the present invention are better understood when the following Detailed Description is read with reference to the accompanying drawings, wherein:

FIG. 1 is an illustration of an example of a process flow associated with automating processing, handling, and facilitating of trade credit in accordance with an embodiment of the invention.

FIG. 2 is an illustration an example of a system in accordance with an embodiment of the invention.

FIGS. 3-7 illustrate examples of methods in accordance with an embodiment of the invention.

FIGS. 8-36 illustrate examples of screenshots of user interfaces in accordance with various embodiments of the invention.

### DETAILED DESCRIPTION

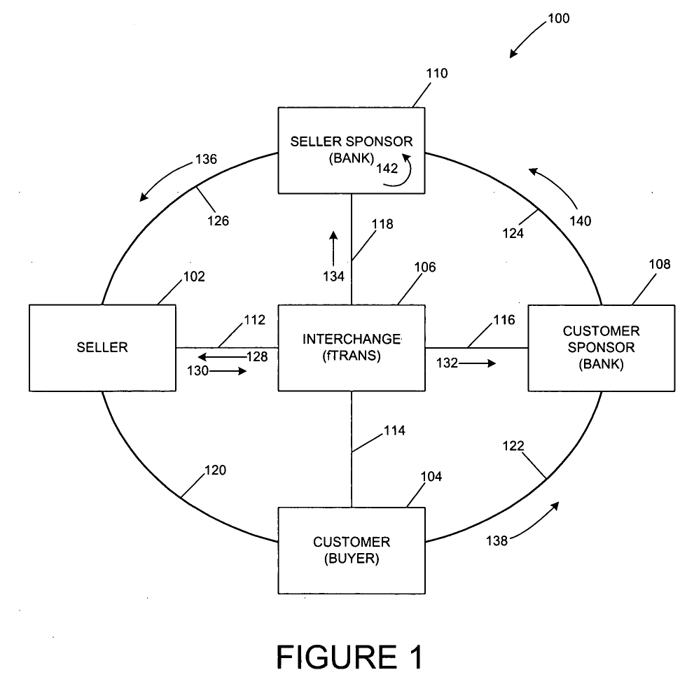

Referring now to the drawings in which like numerals indicate like elements throughout the several figures, FIG. 1 illustrates a process flow of information and payments among financial institutions, a seller, and a customer during the processing, handling, and facilitating of a trade credit transaction in accordance with an embodiment of the invention. In particular, the process 100 shown illustrates automated information and payment flows between various entities during a trade credit transaction when a customer purchases a good, service, and/or intangible from a seller using trade credit.

In the embodiment shown, the seller 102 and customer 104 are business entities in a transaction with each other, such as a seller and a buyer. For example, the seller 102 can be a business selling a good to the customer 104. In another example, the seller 102 can be a business selling a service to the customer 104. In another example, the seller 102 can be a business selling an intangible to the customer 104. In yet another example, the seller 102 be a business selling any combination of goods, services, and/or intangible to the customer 104. In all instances, the customer 104 desires to make a purchase from the seller 102 using trade credit.

An interchange 106 can coordinate the processing, handling, and facilitating of a trade credit transaction among the seller 102, a customer 104, a customer sponsor 108, and a seller sponsor 110. The interchange 106 can act as a credit approval entity when an entity submits a request to approve a trade credit transaction such as a purchase using trade credit. After approval of the trade credit transaction, the interchange 106 can also initiate and process the trade credit transaction such as receiving an invoice from an entity such as a seller 102, and coordinating the various exchanges of information and payment between entities in the trade credit transaction.

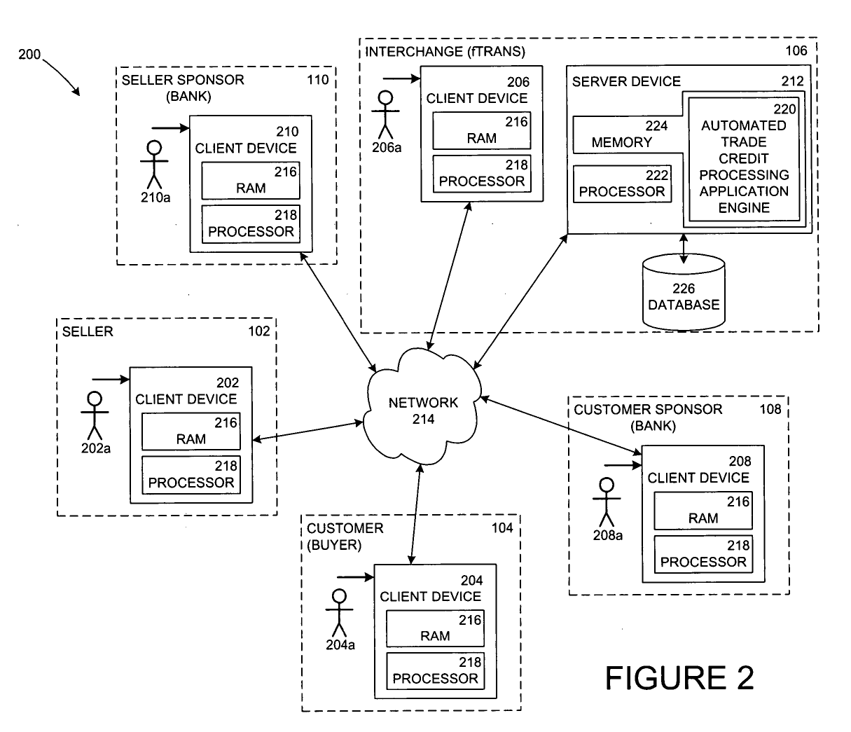

The interchange 106 can be an entity such as a financial institution. In one example, an interchange can be an independently owned and operated entity such as FTRANS Corp. f/k/a Financial Transaction Systems LLC, of Atlanta, Ga. In another example, an interchange can be a cooperative venture owned by other financial institutions such as banks. In the example shown in FIG. 1, the interchange 106 can communicate to the seller 102, customer 104, customer sponsor 108, and seller sponsor 1 10, through an electronic transaction system shown as 200 in FIG. 2. The electronic transaction system 200 can include communication links 112, 114, 116, 118, 120, 122, 124,126 to connect the interchange 106 to each of the seller 102, customer 104, client sponsor 108, and customer sponsor 110. Communication links 112, 114, 116, 118, 120, 122, 124, 126 can be wired and/or wireless communication devices and methods used to facilitate the exchange of signals, information, invoices, monetary funds, and payments, as needed. In one embodiment, a communication link can be facilitated by a postal mail delivery service, such as link 120 and/or 122. In other embodiments, some or all communications links 112, 114, 116, 118, 120, 122, 124, 126 can be facilitated by any combination of communication means such as wired and/or wireless communications devices and methods, and postal mail delivery service.

The customer sponsor 108 can be a financial institution, such as a bank, which issues trade credit to a customer and sponsors that customer in a trade credit transaction. That is, the customer sponsor 108 can qualify a customer for a certain amount of trade credit, and then guarantees any payments owed for purchases of goods, services, and/or intangibles by the customer using the trade credit. If the customer fails to make a payment, the customer sponsor 108 assumes responsibility for making payment on behalf of the customer. For example as shown in FIG. 1, when a particular customer 104 desires trade credit, the customer sponsor 108 qualifies the customer 104 and extends a line of trade credit to the customer depending at least in part on credit information associated with the customer 104 through the interchange 106. When the customer makes a purchase using the trade credit, the customer sponsor 108 can guarantee payment owed by the customer 104 for purchase. When the customer 104 makes a payment owed for the purchase, the customer sponsor 108 receives the payment from the customer 104. In this manner, the customer sponsor 108 assumes any risk that the customer 104 may not or cannot pay for the purchase, thus guaranteeing the payment, and also assumes responsibility and burden of collecting any payments from the customer 104.

The seller sponsor 110 can be a financial institution, such as a bank, which administers an account for a seller and sponsors that seller in a trade credit transaction. That is, the seller sponsor 110 can establish a merchant account for a seller desiring to accept trade credit for a purchase of its goods, services, and/or intangibles. The seller sponsor 110 can then assume responsibility for advancing money to the seller for a purchase from the seller using trade credit, and can also guarantee the sale of goods, services, and/or intangibles by the seller. For example as shown in FIG. 1, when a customer 104 utilizes trade credit for a purchase of goods, services, and/or intangibles from a particular seller 102, the seller sponsor 110 can advance money, when or soon after the purchase is made, to the seller 102 or otherwise credit an account associated with the seller. In this manner, the seller 102 can receive money for the purchase by the customer 104, and the seller sponsor 110 assumes the seller's fraud and/or dispute risk associated with the purchase.

The process 100 illustrated in FIG. 1 is shown by arrows 128, 130, 132, 134, 136, 138, 140, and 142. Each arrow represents a flow of information and/or monetary funds between the various entities associated with a trade credit transaction.

The process 100 begins at arrow 128, in which the seller 102 obtains approval of a trade credit transaction from the interchange 106. Typically, the interchange 106 can host or can otherwise access credit data or other information from an associated database, such as the database shown as 226 In FIG. 2 or a credit reporting database, or from the customer sponsor 108. The interchange 106 can determine whether to approve or deny a request a trade credit transaction based at least in part on information associated with the particular transaction, the seller 102 and/or the customer 104. Approval and/or denial of the particular trade credit transaction can be transmitted from the interchange 106 to the seller 102 via communication link 112.

In at least one embodiment, a line of trade credit can be established for a particular customer. The interchange 106 can determine whether a customer 104 has sufficient credit for a line of trade credit, and can extend or otherwise approve the customer 104 for a line of trade credit. In this manner, the customer 104 can utilize the line of trade credit for multiple purchases and/or trade credit transactions.

If an approval for the trade credit transaction is granted, the process 100 continues to arrows 130 and 132, in which the seller 102 transmits an invoice associated with the purchase to the customer sponsor 108. In one example, an invoice can be an electronic invoice, document, or email, with any representation of information associated with a trade credit transaction including, but not limited to, purchase price, payment terms, buyer or seller-related information, or any other transaction-related information. In the meantime, the seller 102 can provide goods, services, and/or intangibles associated with the purchase to the customer 104. For example, if the seller 102 accepts trade credit for the purchase of a good, service, , and/or intangible the seller 102 can transmit information shown by arrow 130, such as an invoice associated with a purchase of a good, service, and/or intangible from the seller 102, via link 112 to the interchange 106. When the interchange 106 receives the invoice, the interchange 106 can assign the invoice to the customer sponsor 108 by transmitting information shown by arrow 132, including the invoice, to the customer sponsor 108 via link 116. Alternatively, the seller 102 can transmit an invoice associated with the purchase to the customer 104 via link 120, and the customer 104 can transmit the invoice to the customer sponsor directly through link 122 or via the interchange 106 through links 114 and 116.

In any instance, by accepting the invoice associated with the purchase, the customer sponsor 108 assumes the responsibility of receiving payment for the purchase from the customer 104, and also assumes the risk that the customer 104 may not or cannot make payment in full for the purchase. This risk is also known as “seller risk” or “client risk.”

In return, the seller 102 can receive confirmation of the invoice receipt directly from the customer sponsor 108 or through the interchange 106. The customer sponsor 108 can also transmit confirmation of the invoice receipt to the customer 104, including a reminder of any payment terms for the purchase. Payment terms can include an amount of payment, an installment amount, due date or time, a payment instruction, a type of monetary instrument required for payment, and an account number for payment deposit or transfer.

Prior to or after the invoice has been assigned to the customer sponsor 108, the interchange 106 can then implement or otherwise facilitate fraud detection methods and routines to verify that the trade credit transaction between the seller 102 and customer 104 has occurred. If the interchange 106 detects any fraudulent activity, the interchange 106 can notify the various entities involved in the trade credit transaction, including but not limited to the seller 102, customer 104, customer sponsor 108, and seller sponsor 110, to take appropriate measures to combat the fraud such as ceasing or voiding the transaction.

The process 100 continues at arrow 134, in which the seller sponsor 110 is notified of the trade credit transaction. After the interchange 106 receives notification of the trade credit transaction, the interchange 106 can implement credit rules, such as pre-existing credit rules associated with the seller sponsor 110, to determine an amount of monetary funds for the seller sponsor 110 to advance to the seller 102. When the interchange 106 has determined an amount of monetary funds based at least on the credit rules of the seller sponsor 110, the interchange 106 can notify, via link 118, the seller sponsor 110 such as transmitting a recommendation for the amount of monetary funds to advance to the client 102 via the link 126.

The process 100 continues at arrow 136, in which the seller sponsor 110 advances a monetary amount to the seller 102. For example, after the seller sponsor 110 receives notification from the interchange 106, the seller sponsor 110 can advance monetary funds to the client 102 via link 126 or otherwise notify the seller 102 that an account associated with the seller 102 is being credited with funds. The advance can be based in part on at least the recommendation received from the interchange 106.

If the interchange 106 does not implement credit rules to recommend an amount of monetary funds to advance to the seller 102, the client sponsor 110 can implement credit rules itself to determine an amount of monetary funds to advance to the seller 102.

In some instances, the seller sponsor 110 can charge the seller 102 interest on the advanced monetary funds. The interest can include a calculated or predetermined interest rate based on the volume of trade credit transactions the seller 102 participates in a particular time period. In other instances, the seller sponsor 110 can charge the seller 102 a fee based on the volume of trade credit transactions the seller 102 participates in a particular time period. In either of these instances, the interest and/or fee can affect the monetary amount the seller 102 receives from the seller sponsor 110 for the particular trade credit transaction. Calculating or predetermining the interest and/or fee can be performed by the seller sponsor 110, the interchange 106, or any other suitable entity.

The process 100 continues at arrow 138, in which the customer 104 makes a payment to the customer sponsor 108. In the example shown in FIG. 1, the customer 104 can transmit a payment to the customer sponsor 108 via link 124. In some embodiments, the payment can be in accordance with terms of payment previously provided by or otherwise defined by the customer sponsor 108.

The process 100 continues at arrow 140, in which the customer sponsor 108 remits to the seller sponsor 110. In the example shown in FIG. 1, the customer sponsor 108 transmits a payment to the seller sponsor 110 via link 124. In one embodiment, a payment by the customer sponsor 108 to the seller sponsor 110 of some or all of an amount owed by the customer on the invoice is called a settlement. In another embodiment, when the customer sponsor 108 transmits a payment to the seller sponsor 110, the customer sponsor also sends a notification, such as an electronic message or email, to the seller sponsor 110 to settle the invoice. Regardless of whether the customer sponsor 108 has received payment from the customer 104, the customer sponsor 108 is obligated to make a payment to the seller sponsor 110 for the trade credit transaction. In this manner, a payment for the purchase from the seller 102 made by the customer 104 using trade credit is ultimately transmitted to the seller sponsor 110, which has previously advanced monetary funds to the seller 102 and is owed the payment by the customer sponsor 108.

If, however, the customer 104 fails to or cannot make a payment to the customer sponsor 108 as shown by arrow 138, the customer sponsor 108 still bears responsibility for remitting to the seller sponsor 110. This is a risk that the customer sponsor 108 has previously assumed in the event the customer 104 cannot pay, previously described as “seller risk” or “client risk.”

The process 100 continues at arrow 142, in which the seller sponsor 110 allocates the payment received from the customer sponsor 108. Based at least in part on lending rules received from the interchange 106 via link 118, the seller sponsor 110 can allocate monetary funds between one or more accounts associated with the seller 102, such as a loan account, deposit account, and/or bank holding account administered by the seller sponsor 110 or another related entity.

At arrow 142, the process 100 ends.

The number of steps performed in the process 100 above can be fewer or greater than those described above in accordance with other embodiments of the invention. Furthermore, the order of the steps performed in the process 100 above can be arranged differently in accordance with other embodiments of the invention. Moreover, other processes to process, handle, and facilitate a trade credit transaction can be accomplished with fewer or greater numbers of information, payments, entities, sponsors, and/or parties in accordance with other embodiments of the invention.

FIG. 2 is an illustration of example system components for a system in accordance with an embodiment of this invention. The system 200 shown in FIG. 2 comprises multiple client devices 202, 204, 206, 208, 210 in communication with a server device 212 over a network 214. Each of the client devices 202, 204, 206, 208, 210 can be associated with a respective entity in a trade credit transaction, such as seller 102, customer 104, interchange 106, customer sponsor 108, and seller sponsor 110, shown in FIGS. 1 and 2. The network 214 shown can comprise the Internet, an automated or electronic financial transaction network, any other suitable network, or a combination of such networks. In other embodiments, other networks, wired and wireless, such as an intranet, local area network, wide area network, or broadcast network may be used. Moreover, methods according to the present invention may operate within a single client or server device.

Each client device 202, 204, 206, 208, 210 shown in FIG. 2 preferably comprises a computer-readable medium. The computer-readable medium shown can comprise a random access memory (RAM) 216 coupled to a processor 218. The processor 218 can execute computer-executable program instructions stored in the memory 216. Such processors may comprise a microprocessor, an Application-Specific Integrated Circuit (ASIC), a state machine, or other processor. Such processors comprise, or may be in communication with, media, for example computer-readable media, which stores instructions that, when executed by the processor, cause the processor to perform the steps described herein.

Embodiments of computer-readable media may comprise an electronic, optical, magnetic, or other storage or transmission device capable of providing a processor, such as the processor 218 of client 202, with computer-readable instructions. Other examples of suitable media may comprise a floppy disk, Compact Disk Read Only Memory (CD-ROM), magnetic disk, memory chip, Read Only Memory (ROM), Random Access Memory (RAM), an ASIC, a configured processor, all optical media, all magnetic tape or other magnetic media, or any other suitable medium from which a computer processor can read instructions or on which instructions, code, or other data may be stored. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

Client devices 202, 204, 206, 208, 210 may also comprise a number of external or internal devices such as a magnetic or smart card reader, biometric data collection devices, mouse, a CD-ROM, a keyboard, a display, or other input or output devices. Examples of client devices 202, 204, 206, 208, 210 are card terminals, personal computers, media center computers, televisions, television set-top boxes, digital assistants, personal digital assistants, cellular phones, mobile phones, smart phones, pagers, digital tablets, laptop computers, Internet appliances, and other processor-based devices. In general, a client device 202, 204, 206, 208, 210 may be any type of processor-based platform that may be connected to a network 214 and that interacts with one or more application programs. Client devices 202, 204, 206, 208, 210 may operate on any operating system, such as Microsoft® Windows® or Linux, capable of supporting one or more client application programs. For example, the client device 202 shown comprises a personal computer executing client application programs, also known as client applications. The client applications can be contained in memory 216 and can comprise, for example, a media player application, a presentation application, an Internet browser application, a calendar/organizer application, and any other application or computer program capable of being executed by a client device.

Through the client devices 202, 204, 206, 208, 210, users 202a, 204a, 206a, 208a, 210a can communicate over the network 214 with each other and with other systems and devices coupled to the network 214. As shown in FIG. 2, a server device 212 is also coupled to the network 214. For example in the embodiment shown in FIG. 2, a user 202a can operate a client 202 and to interact with the server device 212 and formulate a request for approval of a trade credit transaction. The client 202 sends a signal corresponding to the request via the network 214 to the server 212.

In one example in one embodiment, a user 202a can locate a trade credit account associated with a customer such as 104. The user 202a can input into the client device 102a a purchase price associated with a good, service, and/or intangible that the customer 104 desires to purchase. The client device 202a can transmit to the server 212 some or all of the following information: a trade account number, purchase price of a good, service, and/or intangible, any other information provided by the customer or entered by a user, and information associated with the client device 202a. In this manner, a request for approval of a trade credit transaction can be transmitted for approval.

In one example in one embodiment, using a card reader associated with a client device such as 202, a user 202a can swipe or otherwise read a magnetic strip on a card associated with a customer such as 104. The magnetic strip can comprise a trade credit account number and other identifying or verification information associated with a customer 104. The user 202a can input into the client device 102a a purchase price associated with a good, service, and/or intangible that the customer 104 desires to purchase. The client device 202a can transmit to the server 212 some or all of the following information: a trade account number, purchase price of a good, service, and/or intangible, any other information read from the card or entered by a user, and information associated with the client device 202a. In this manner, a request for approval of a trade credit transaction can be transmitted for approval.

The server device 212 shown in FIG. 1 comprises a server executing at least one automated trade credit processing application program, also known as the automated trade credit processing application engine 220 or automated trade credit transaction processing program. Similar to the client devices 202, 204, 206, 208, 210, the server device 212 shown in FIG. 2 comprises a processor 222 coupled to a computer-readable memory 224. Server device 212, depicted in FIG. 2 as a single computer system, may be implemented as a network of computer processors. Examples of a server device are servers, mainframe computers, networked computers, a processor-based device, and similar types of systems and devices. Client processors 218 and the server processor 222 can be any of a number of well known computer processors, such as processors from Intel Corporation of Santa Clara, Calif. and Motorola Corporation of Schaumburg, Ill.

Memory 224 on the server device 212 can contain the automated trade credit processing application engine 220. An automated trade credit processing application engine 220 can comprise a software or hardware application that is configured to automatically process, handle, and facilitate a trade credit transaction. In one embodiment, an automated trade credit processing application engine 220 can be the Positive Cash PIus™ software operated by FTRANS Corp. f/k/a Financial Transaction Systems LLC, of Atlanta, Ga. In response to a request for an approval of a trade credit transaction from a user 202a operating a client 202, the automated trade credit processing application 220 shown in FIG. 2 can begin processing, handling, and facilitating a trade credit transaction.

In one example of one embodiment, a request for approval of a trade credit transaction received from a client 202 can be transmitted from a server 212 to the automated trade credit processing application engine 220. The automated trade credit processing application engine 120 can process the request to grant or deny approval of the trade credit transaction. For example, the automated trade credit processing application engine can verify whether a particular customer has previously opened or has been previously approved for a line of trade credit, check any identifying and/or verification information, or check information entered by a user such as 202a. If the transaction is approved, the automated trade credit processing application engine 220 can inform the seller 102 via the network 214 and client 202 from which the initial request was transmitted. Upon receiving approval of the trade credit transaction, the user 202a can further facilitate the transaction.

In one example of one embodiment, a request for approval of a trade credit transaction received from a client 202 can be transmitted from a server 212 to the automated trade credit processing application engine 220. The automated trade credit processing application engine 120 can process the request to grant or deny approval of the trade credit transaction. For example, the automated trade credit processing application engine can perform a credit check, check whether a trade credit account number is valid, check identifying and/or verification information, or check information entered by a user 202a. If the transaction is approved, the automated trade credit processing application engine 220 can generate an authorization code, and transmit the code via the network 214 to the client 202 from which the initial request was transmitted. Upon receipt of the authorization code, the client 202 can provide authorization of the trade credit transaction to a user such as 202a, who can further facilitate the transaction.

The server device 212 can also communicate with at least one database 226, such as a credit reporting database, to retrieve and/or store information associated with facilitating a trade credit transaction. The database 226 can comprise one or more storage devices with credit files, credit data, information associate with a seller, information associated with a customer, information associated with a prior trade credit transaction, or any other information which can be used to facilitate a trade credit transaction.

Although the processes described herein are described in relation to the client and server or servers, a client may perform any or all of the processes described as being performed by a server. Similarly, a server or servers may perform any or all of the processes described herein as being performed by a client, although the invention is not limited to client/server architecture but can run on any desired topology or architecture as deemed fit for the purposes, whether existing as of the time of the writing of this document or thereafter.

Embodiments of the present invention can comprise systems having different architecture than that which is shown in FIG. 2. For example, in some systems according to the present invention, server device 212 may comprise a single physical or logical server. The system 200 shown in FIG. 2 is merely an example, and is used as an environment to help explain the example processes and methods shown in FIGS. 1, and 3-6.

As shown in FIG. 2, an example automated trade credit processing application engine 220 can include one or more functional components to accomplish some or all of the following functionality: grant or deny approval for a trade credit transaction, perform or facilitate a credit check of a business entity or customer, collect credit data information from entities, recruit entities to use trade credit or participate in trade credit transactions, conduct fraud detection methods or routines for a trade credit transaction, execute or apply credit rules to determine an advance amount for a trade credit transaction, execute or apply lending rules to allocate funds between accounts for a trade credit transaction, settle a trade credit transaction online, monitor invoices and payments associated with a trade credit transaction, generate and store accounting entries for a trade credit transaction in a database, track account receivables (A/R), and resolve customer a dispute over delivery of a good, service, and/or intangible to a customer. Other functions, components, modules, or sub-components for an automated trade credit processing application engine 220 can exist.

In the embodiment shown in FIG. 2, the automated trade credit processing application engine 220 can provide a user interface for use of the automated trade credit processing application engine 220 by users 202a, 204a, 206a, 208a, 210a via the network 214. The user interface can provide users 202a, 204a, 206a, 208a, 210a with on-line accessibility to details of a particular trade credit transaction, statistics of a user's trade credit transactions, credit rules, lending rules, and on-line functionality of the automated trade credit processing application engine 220. The automated trade credit processing application engine 220 can also provide a user interface for a user 202a, 204a, 206a, 208a, 210a to interact with the automated trade credit processing application engine 220. For example, if additional information is needed from a seller to initiate a trade credit transaction with a customer, a user 202a could input additional data associated with the customer via the user interface, and transmit the data to the automated trade credit processing application engine 220 for processing. The automated trade credit processing application engine 220 could then process the additional data to grant or deny the request for the trade credit transaction, or prompt the seller to input more data associated with the customer.

In one embodiment, an automated trade credit processing application engine 220a can include a transaction approval module adapted to facilitate granting or denying approval for a trade credit transaction. The transaction approval module can collect and utilize credit data associated with customers such as businesses, governments, and other entities. Data can be stored in and/or accessed from one or more associated databases, such as database 226, a credit reporting database, or any other suitable database or data storage device. In some instances, the transaction approval module can perform or facilitate a credit check of a business, government, entity, or customer. In one embodiment, a transaction approval module can provide, in response to a request from a seller to approve a trade credit transaction, an email communication to the seller that the transaction has been approved or denied.

In yet another embodiment, an automated trade credit processing application engine 220a can include a fraud detection module adapted to implement or otherwise facilitate fraud detection methods or routines for a trade credit transaction. Fraud detection methods and routines can include, but are not limited to, implementing a rule, criteria, flowchart, algorithm, matrix, decision tool, strategy, or any other routine or device to verify any information associated with a trade credit transaction. For example, fraud detection methods can include verifying that a customer has purchased a good, service, and/or intangible from a seller, verifying shipment to or receipt of the good, service, and/or intangible by the customer, and verifying that an invoice has been assigned by a seller to a customer sponsor. In one embodiment, a fraud detection module can, in response to detecting fraudulent activity for a particular trade credit transaction, add information to a credit reporting database indicating fraudulent activity, and cease further transactions with an entity associated with the fraudulent activity.

In another embodiment, an automated trade credit processing application engine 220a can include a credit rule module adapted to implement or otherwise implement credit rules to determine a monetary amount to advance to a seller for a trade credit transaction. Credit rules can include, but are not limited to, a rule, criteria, flowchart, algorithm, matrix, decision tool, strategy, or any other routine or device to calculate a monetary amount based in part on at least the trade credit transaction. A monetary amount can also be based in part on least an amount of collateral held by a client sponsor or related entities, risk associated with the trade credit transaction, the risk or credit score associated with a client, the risk or credit score associated with a customer, or the number or volume of trade credit transactions a client participates in. For example, in one embodiment, credit rules provided by a seller sponsor can be utilized by an interchange to determine an amount of monetary funds to advance to a seller as well as an interest rate and fee to charge the seller based in part on the volume of trade credit transactions the seller participates in. Such credit rules can be modified by the seller sponsor, and stored by the credit rule module in a database, such as 226, for subsequent retrieval and use.

In another embodiment, an automated trade credit processing application engine 220a can include a lending rule module adapted to implement or otherwise facilitate lending rules to allocate funds between one or more accounts for a trade credit transaction. Lending rules can include, but are not limited to, a rule, criteria, flowchart, algorithm, matrix, decision tool, strategy, or any other routines or devices to determine an amount of monetary funds to allocate to an account associated with a seller. A monetary amount can be based in part on at least advances previously made to a seller, interest and/or fees charged to a seller, and payments received from a customer sponsor. In one example of one embodiment, a lending rule module can implement or otherwise facilitate pre-existing lending rules provided by a seller sponsor to determine an amount of monetary funds to allocate between an account associated with a seller, such as a seller loan account, and a deposit account. Such lending rules can be modified by the seller sponsor, and stored by the lending rule module in a database, such as 226, for subsequent retrieval and use.

In yet another embodiment, an automated trade credit processing application engine 220a can include a transaction settlement module adapted to settle a trade transaction. An invoice and any payments associated with a trade credit transaction can be monitored by a transaction settlement module, and corresponding accounting entries and records can be generated and stored in an associated database such as 226, or other data storage device as needed. A transaction settlement module can also monitor and track account receivables (A/R) for an entity, send appropriate notifications to various entities when account receivables are due, late, or received, and send other appropriate notifications to, for example, a customer sponsor 108 and/or seller sponsor 10 when an invoice is settled. A transaction settlement module can also include a user interface with a transaction ledger for an entity to view and settle transactions as needed. In one example, a transaction ledger can be provided in a double accounting-type entry from a particular view of the user.

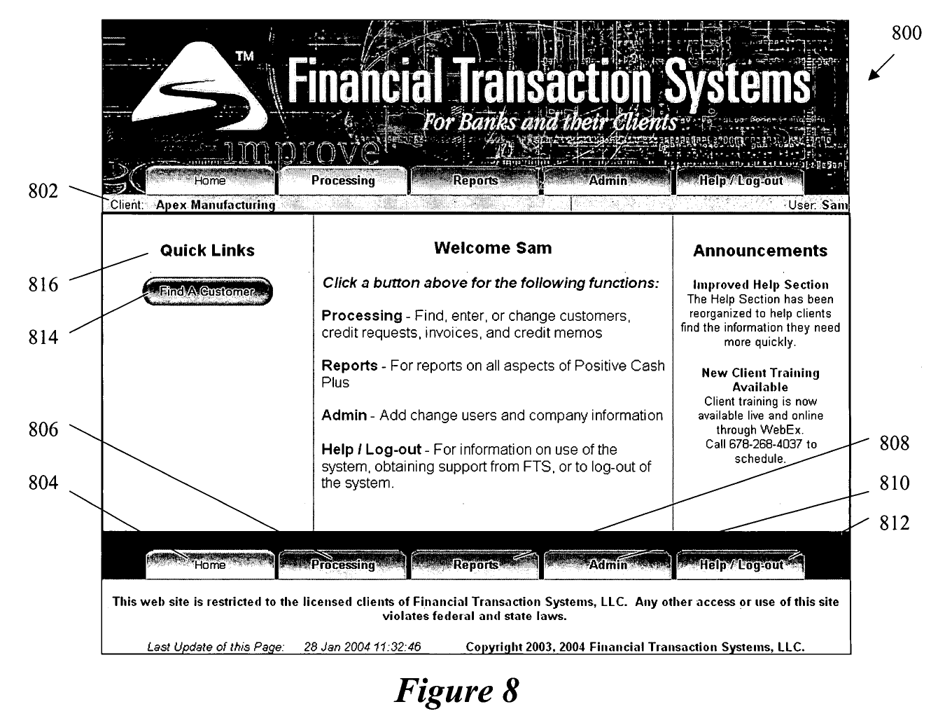

For example, in one embodiment, a transaction settlement module can provide a user interface for a seller to view some or all outstanding trade credit transactions associated with the seller, including information such as payments associated with such trade credit transactions, fees and interest charges associated with such transactions, and the status of settlement of such transactions. The transaction settlement module can also permit the seller to enter information associated with when payments are received from a seller sponsor, view information associated with some or all payments received from a seller sponsor, and match such payments to particular trade credit transactions and/or purchases made from the seller using trade credit. If a seller desires a statement or other record of some or all trade credit transactions associated with the seller, the transaction settlement module can provide or otherwise facilitate transmission of a statement or other record to the seller. Examples of a user interface for a seller to interact with a trade credit processing application program according to an embodiment of the invention are illustrated in FIGS. 8-21.

In another example in another embodiment, a transaction settlement module can provide a user interface for a customer to view some or all outstanding trade credit transactions associated with the customer, including information such as completed payments associated with such trade credit transactions, scheduled payments associated with such trade credit transactions, and the status of settlement of such transactions. The transaction settlement module can also permit the customer to enter information associated with when payments are made, view information associated with some or all payments paid to the customer sponsor, and match such payments to particular trade credit transactions and/or purchases made from one or more sellers using trade credit. If a customer desires a statement or other record of some or all trade credit transactions associated with the customer, the transaction settlement module can provide or otherwise facilitate transmission of a statement or other record to the seller.

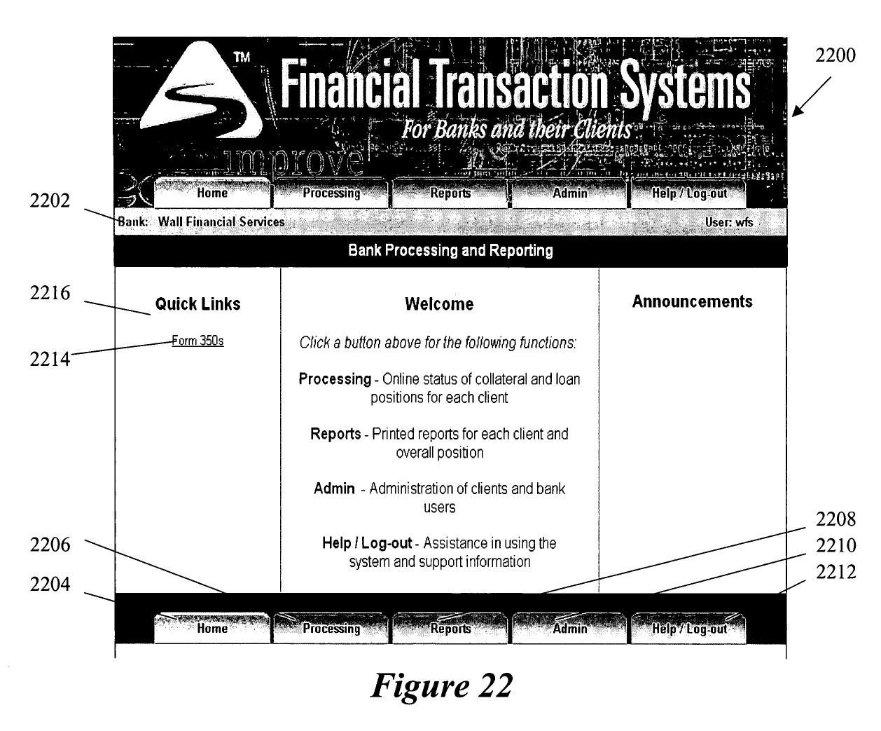

In yet another example, a transaction settlement module can provide a user interface for a seller sponsor to view some or all outstanding trade credit transactions associated with the seller sponsor including information such as payments associated with such trade credit transactions, fees and interest charges associated with such transactions, and the status of settlement of such transactions. The transaction settlement module can also permit the seller sponsor to enter information associated with when payments are made to a seller, view information associated with some or all payments paid to one or more sellers, and match such payments to particular trade credit transactions and/or purchases made from such sellers using trade credit. If a seller sponsor desires a statement or other record of some or all trade credit transactions associated with the seller sponsor, the transaction settlement module can provide or otherwise facilitate transmission of a statement or other record to the seller sponsor. Examples of a user interface for a seller sponsor to interact with a trade credit processing application program according to an embodiment of the invention are illustrated in FIGS. 22-35.

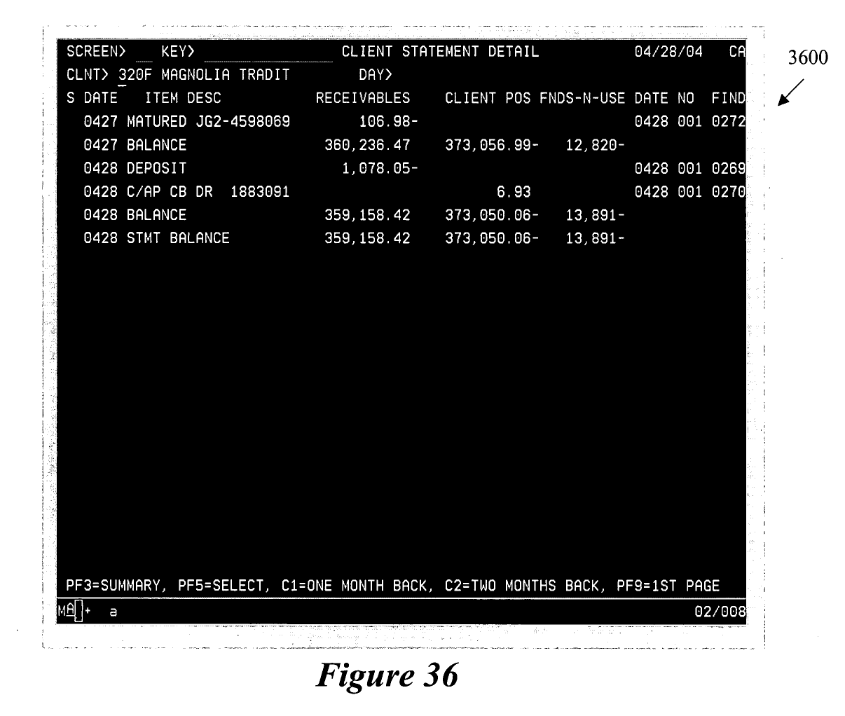

In yet another example in another embodiment, a transaction settlement module can provide a user interface for a customer sponsor to view some or all outstanding trade credit transactions associated with the customer sponsor, including information such as status of account receivables (A/R), completed payments associated with such trade credit transactions, scheduled payments associated with such trade credit transactions, and the status of settlement of such transactions. The transaction settlement module can also permit the customer sponsor to enter information associated with payments or account receivables (A/R) received, view information associated with some or all payments paid by one or more customers, and match such payments and account receivables (A/R) to particular trade credit transactions and/or purchases made by such customers using trade credit. If a customer sponsor desires a statement or other record of some or all trade credit transactions associated with the customer sponsor, the transaction settlement module can provide or otherwise facilitate transmission of a statement or other record to the customer sponsor. An example of a user interface for a customer sponsor to interact with a trade credit processing application program according to an embodiment of the invention is illustrated in FIG. 36.

In another embodiment, an automated trade credit processing application engine 220a can include a customer service module adapted to resolve customer a dispute over delivery of a good, service, and/or intangible to a customer. A customer service module can include a user interface for an entity to submit disputes over purchase terms or delivery of goods, services, and/or intangibles. For example, in one embodiment, a customer service module can provide a user interface for a customer to notify a seller sponsor that a particular seller has not yet delivered goods associated with a purchase from the seller. In another embodiment in another example, a customer service module via a user interface can provide information to a seller sponsor a particular seller has not yet delivered goods associated with a purchase from the seller. In this instance, the seller sponsor can notify the seller, and either withhold further payment from the seller, or debit an account associated with the seller if payment has been previously advanced to the seller.

In another example in another embodiment, a customer service module can be utilized to recruit entities to participate in trade credit transactions. The customer service module can be used to search a database, such as 226 or a credit reporting database, to determine or otherwise prequalify an entity for a line of trade credit. A seller, for example, could utilize the customer service module to generate and transmit pre-approved offers of trade credit to potential customers. Interested potential customers can respond to a pre-approved offer, and transmit or otherwise contact the customer service module via the network 214. The customer service module can then collect information associated with the potential customer, such as identifying and credit data, via the network 214, and store the information in a database, such as 226 or a credit reporting database, for subsequent use. Other entities associated with trade credit transactions, such as an interchange, customer, customer sponsor, and seller sponsor, can utilize a customer service module to determine or otherwise prequalify another entity for a line of trade credit.

Collectively, the components of the automated trade credit processing application engine 220 can process a trade credit transaction and coordinate the transfer of information and funds between entities in the trade credit transaction. Users 202a, 204a, 206a, 208a, 210a can focus more on analyzing how trade credit is used, increasing trade credit usage, how trade credit data statistics will be presented, and less about managing the aspects of performing a trade credit transaction. The automated processing, handling, and facilitating of trade credit transactions can lead to increased usage and acceptance of trade credit for business to business (B2B) and other types of transactions in the United States and other countries.

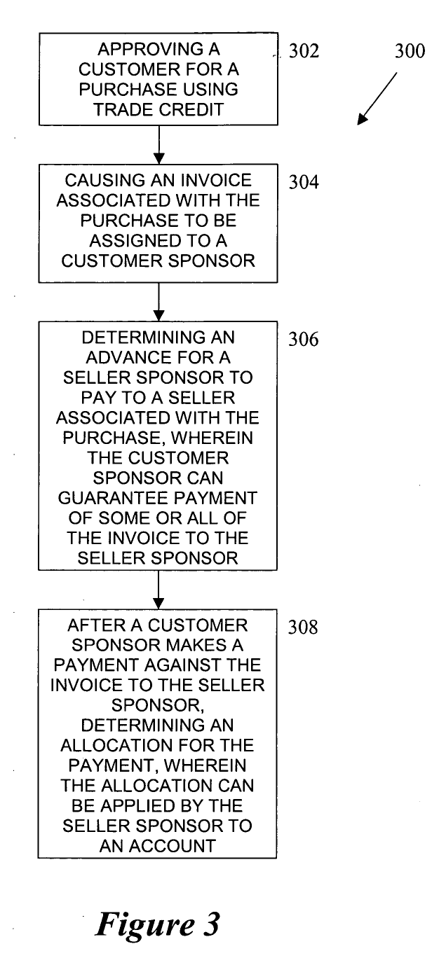

Example methods that can be performed by an automated trade credit transaction processing engine, in accordance with embodiments of the invention, are illustrated in FIGS. 3-8. The methods shown in FIGS. 3-8 can be implemented in conjunction with the example system 200 shown in FIG. 2. These and other methods can be performed or otherwise implemented on other system embodiments in accordance with other embodiments of the invention.

FIG. 3 illustrates a computer-implemented method for automating processing of a trade credit transaction between a seller and a customer. In one embodiment, the method 300 can be implemented or otherwise facilitated by an interchange such as 106 interacting with an automated trade credit processing application engine 220 and operating in conjunction with the system 200 shown in FIG. 2.

The method 300 begins at block 302, in which an automated trade credit transaction processing program on a computer system is provided to approve a customer for a purchase using trade credit. For example, the interchange 106 can receive a request for trade credit from a seller 102 desiring to sell a good, service, and/or intangible. The interchange 106 can grant or deny the request. If the interchange approves the request for trade credit, the method 300 can continue.

Block 302 is followed by block 304, in which an invoice associated with the purchase is caused to be assigned to a customer sponsor. For example, the interchange 106 can receive transmission of an invoice associated with the purchase, and the interchange can transmit the invoice to a customer sponsor 108, thereby causing the assignment of the invoice to the customer sponsor 108.

Block 304 is followed by block 306, in which an advance for a seller sponsor to pay to a seller associated with the purchase is determined, wherein the customer sponsor can guarantee payment of some or all of the invoice to the seller sponsor. For example, the interchange 106 can determine an advance for a seller sponsor to pay a seller. The advance can be made by the seller sponsor 110 as long as the customer sponsor 108 guarantees payment of some or all of the invoice to the seller sponsor 110. In at least one embodiment, the advance can be determined by the interchange 106 based at least in part on one or more lending rules associated with or otherwise provide by the seller sponsor 110.

In another embodiment, the interchange 106 can perform a fraud detection routine or method on the transaction prior to determining an advance.

Block 306 is followed by block 308, in which after a customer sponsor makes a payment against the invoice to the seller sponsor, an allocation for the payment can be determined, wherein the allocation can be applied by the seller sponsor to an account associated with the seller. For example, when the customer sponsor 108 makes at least one payment against the invoice to the seller sponsor 110, the interchange 106 can receive notification of this event. The interchange 106 can determine an allocation based at least in part on one or more credit rules associated with the seller sponsor 110, and can notify the seller sponsor 110 of the allocation. The allocation can be applied by the seller sponsor 110 to an account associated with the seller 102, such as a loan account and a deposit account.

The method 300 ends at block 308.

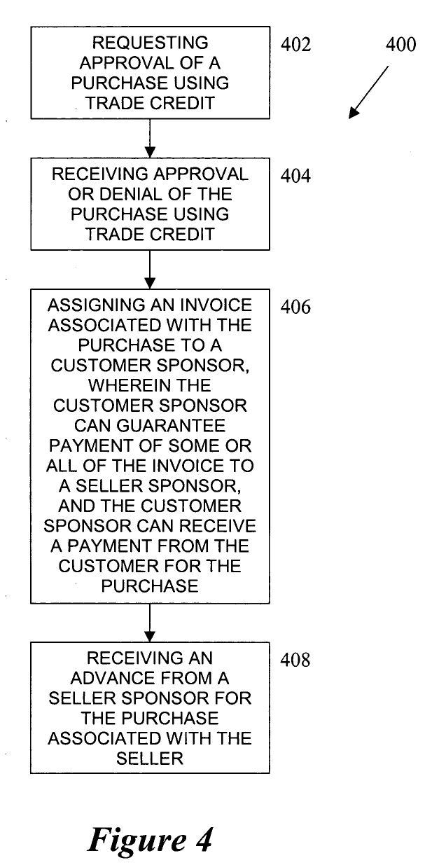

FIG. 4 illustrates a computer-implemented method for using trade credit to facilitate a purchase for a customer. In one embodiment, the method 400 can be implemented or otherwise facilitated by a seller such as 102 interacting with an automated trade credit processing application engine 220 and operating in conjunction with the system 200 shown in FIG. 2.

The method 400 begins at block 402, in which an automated trade credit transaction processing program on a computer system is provided to request approval of a purchase using trade credit. For example, a seller 102 can request approval of a purchase using trade credit from an interchange 106. The seller 102 can transmit the request via network 214 to the interchange 106, and the interchange 106 can grant or deny the request. When the interchange 106 approves the request, the method 400 can continue.

Block 402 is followed by block 404, in which approval of the purchase is received. For example, the interchange 106 can transmit approval of the purchase using trade credit via the network 214 to the seller 102.

Block 404 is followed by block 406, in which an invoice associated with the purchase is assigned to a customer sponsor, wherein the customer sponsor can guarantee payment of some or all of the invoice to a seller sponsor, and the customer sponsor can receive a payment from the customer for the purchase. For example, an invoice associated with the purchase can be transmitted by the seller 102 to the interchange 106, and the interchange 106 then transmits the invoice to the customer sponsor 108, thereby assigning the invoice to the customer sponsor. The customer sponsor 108 can guarantee payment of some or all of the invoice to a seller sponsor 110, and the customer sponsor 108 can receive a payment from the customer 104 for the purchase. In this example, an invoice can be an electronic invoice, document, or email, with any representation of information associated with a trade credit transaction including, but not limited to, purchase price, payment terms, buyer or seller-related information, or any other transaction-related information.

In another embodiment, an invoice associated with the purchase can be transmitted by the seller 102 directly to a customer sponsor 108, thereby assigning the invoice to the customer sponsor 108.

Block 406 is followed by block 408, in which an advance is received from a seller sponsor for the purchase. For example, the interchange 106 can determine based at least in part on one or more lending rules an advance for the seller sponsor 110 to transmit to the seller 104 for the purchase. In at least one embodiment, the one or more lending rules can be associated with or otherwise provided by the seller sponsor 110.

The method 400 ends at block 408.

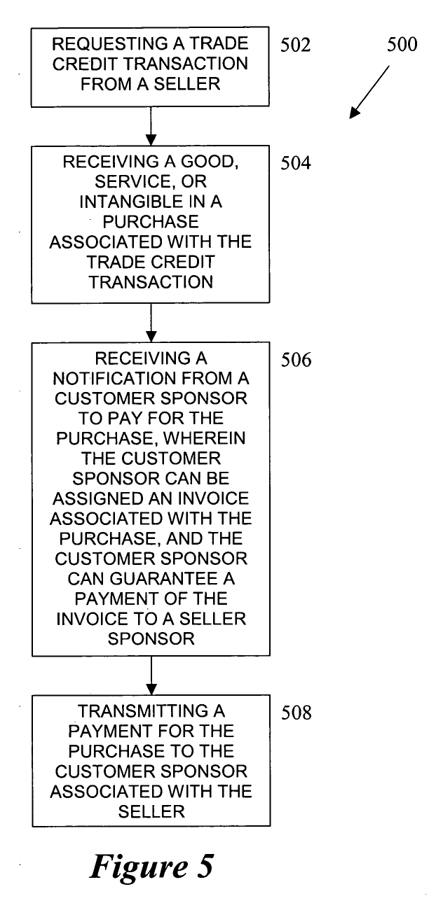

FIG. 5 illustrates a computer-implemented method for using trade credit to facilitate a purchase from a seller. In one embodiment, the method 500 can be implemented or otherwise facilitated by a buyer or customer such as 104 interacting with an automated trade credit processing application engine 220 and operating in conjunction with the system 200 shown in FIG. 2.

The method 500 begins at block 502, in which an automated trade credit transaction processing program on a computer system is provided to request a trade credit transaction from a seller. For example, if a customer 104 or buyer desires to make a purchase using trade credit, the customer requests the transaction from a seller such as 102. If the seller 102 accepts trade credit for the purchase, the method 500 can continue.

Block 502 is followed by block 504, in which a good, service, and/or intangible in a purchase associated with the trade credit transaction is received. For example, after the seller 102 accepts trade credit for the purchase, the customer 104 or buyer can receive the good, service, and/or intangible desired from the trade credit transaction.

Block 504 is followed by block 506, in which a notification from a customer sponsor is received to pay for the purchase, wherein the customer sponsor can be assigned an invoice associated with the purchase, and the customer sponsor can guarantee a payment of the invoice to a seller sponsor. For example, the customer 104 or buyer can receive a notification from a customer sponsor 108 via network 214 to pay for the purchase. The customer sponsor 108 can be assigned an invoice associated with the purchase, and the customer sponsor 108 can guarantee some or all payments owed by the customer 104 or buyer for the purchase to a seller sponsor 110. In one embodiment, an invoice can be an electronic representation of trade credit transaction-related information, such as an electronic invoice, document, or email.

Block 506 is followed by block 508, in which a payment for the purchase is transmitted to the customer sponsor. For example, the customer 104 or buyer can transmit a payment to the customer sponsor 108 for the purchase. The customer sponsor 108 can then apply the payment against the invoice, and can continue receiving payments from the customer 104 or buyer until the invoice is satisfied.

The method 500 ends at block 508.

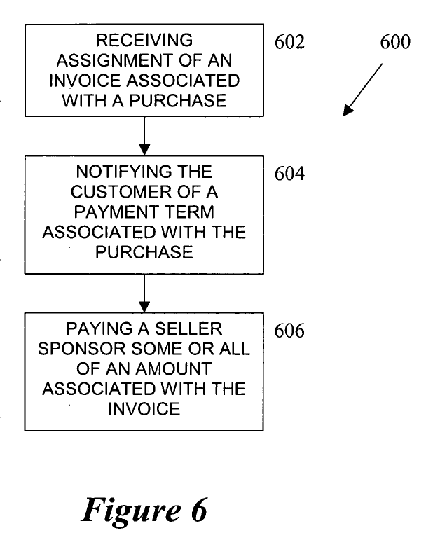

FIG. 6 illustrates a computer-implemented method for processing a trade credit transaction. In one embodiment, the method 600 can be implemented or otherwise facilitated by a customer sponsor such as 108 interacting with an automated trade credit processing application engine 220 and operating in conjunction with the system 200 shown in FIG. 2.

The method 600 begins at block 602, in which an automated trade credit transaction processing program on a computer system is provided to receive assignment of an invoice associated with a purchase made by a customer using trade credit, wherein payment of the invoice is guaranteed to a seller sponsor. For example, when a purchase is made by a customer 104 or buyer using trade credit, an invoice associated with the purchase can be assigned by the seller 102 to the customer sponsor 108. In one embodiment, the seller 102 can transmit an invoice to an interchange 106 via network 214, and the interchange 106 can transmit the invoice to the customer sponsor via the network 214, thereby assigning the invoice to the customer sponsor. In another embodiment, the seller 102 can directly transmit the invoice to the customer sponsor 108 via the network 214. In either instance, the customer sponsor 108 can receives the invoice, and can accept assignment of the invoice for the purchase. The customer sponsor 108 can then guarantee payment of the invoice to a seller sponsor, regardless of whether the customer 104 or buyer makes a payment to the customer sponsor 108 for the purchase or against the invoice.

Block 602 is followed by block 604, in which the customer is notified of a payment term associated with the purchase. For example, upon assignment of the invoice, the customer sponsor 108 can notify the customer 104 or buyer via the network 214 of a payment term associated with the purchase. In another embodiment, the interchange 106 or the seller 102 can notify the customer 104 or buyer of a payment term associated with the purchase.

Block 604 is followed by block 606, in which a seller sponsor is paid some or all of an amount associated with the invoice. For example, the customer 104 or buyer can transmit a payment towards some or all of the invoice to the customer sponsor 108 via network 214. The customer 104 or buyer can continue transmitting payments to the customer sponsor 108 until the invoice is satisfied.

The method 600 ends at block 606.

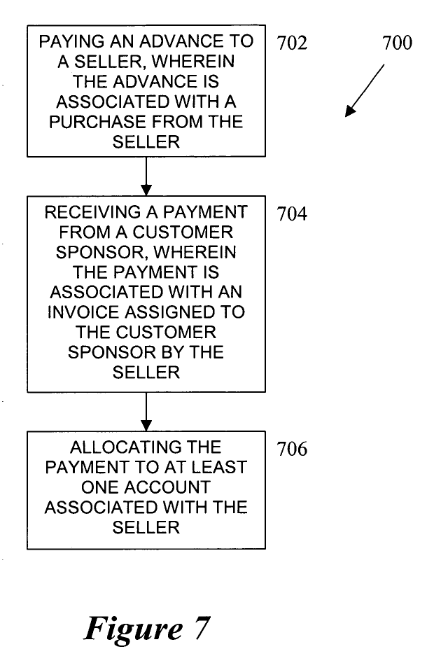

FIG. 7 illustrates a computer-implemented method for processing a trade credit transaction. In one embodiment, the method 700 can be implemented or otherwise facilitated by a seller sponsor such as 110 interacting with an automated trade credit processing application engine 220 and operating in conjunction with the system 200 shown in FIG. 2.

The method 700 begins at block 702, in which an automated trade credit transaction processing program on a computer system is provided to pay an advance to a seller, wherein the advance is associated with a purchase from the seller. For example, when a purchase is made by a customer 104 or buyer using trade credit, a seller sponsor 110 can pay a seller 102 an advance towards the purchase. The seller sponsor 110 can receive notification from an interchange 106 of an amount of the advance, or can otherwise determine the advance. In at least one embodiment, the advance can be determined based at least in part on one or more lending rules associated with the seller sponsor 110. The seller 102 can receive the advance from the seller sponsor 110 via network 214, or the seller 102 can be notified via network 214 of a deposit of an advance into an account held by the seller 102 and administered by the seller sponsor 110. In either instance, the seller sponsor 110 pays the seller 102 an advance for the purchase.

Block 702 is followed by block 704, in which a payment is received from a customer sponsor, wherein the payment is associated with an invoice assigned to the customer sponsor by the seller; and. For example, the seller sponsor 110 can receive a payment from a customer sponsor 108, wherein the payment is based at least in part on an invoice associated with the purchase and assigned by the seller 102 to the customer sponsor 108. The customer sponsor 108 can guarantee payment of some or all of the invoice to the seller sponsor, regardless of whether a customer 104 or buyer pays the customer sponsor 108 for the purchase or makes a payment towards the invoice. The seller sponsor 110 can receive a payment from the customer sponsor 108 via the network 214.

Block 704 is followed by block 706, in which the payment is allocated to at least one account associated with the seller. For example, the interchange 106 can be notified of the payment by the customer sponsor 108 to the seller sponsor. Based at least in part on one or more credit rules associated with the seller sponsor 110, an allocation can be determined by the interchange 106 or seller sponsor 110. The seller sponsor 110 can receive notification of the allocation from the interchange 106 or otherwise determine the allocation, and apply the allocation to an account associated with the seller 102, such as a loan account and a deposit account.

The method 700 ends at block 706.

FIGS. 8-36 illustrate screenshots of example user interfaces for an automated trade credit processing application engine in accordance with embodiments of the invention. The automated trade credit processing application engine can provide or otherwise facilitate various tools for a user, such as a user associated with a seller, a customer or buyer, seller sponsor, customer sponsor, or interchange, to interact with to transmit, exchange, and review information associated with a trade credit transaction. Tools can include functional tabs, command buttons, links, menus, reports, or any other device or method which can facilitate or otherwise implement a series of one or more functions or commands.

One example of a graphical user interface that can be implemented by automated trade credit processing application engine is a financial transaction website interface for a user, such as a seller. Example screenshots of a user interface for a financial transaction website interface for a user, such as a seller, are shown in FIGS. 8-21. For example in FIG. 8, a user 202a operating an associated client device 202 can access a user interface such as an overview webpage 800 via network 214. The overview webpage 800 can be customized for the user 202a, such as a seller 102, for example “Apex Manufacturing” 802. Using a mouse or other input device associated with the client device 202, the user 202a can select a functional tab 804, 806, 808, 810, 812 and/or command button 814 corresponding to one or more subsequent webpages associated with one or more corresponding functions.

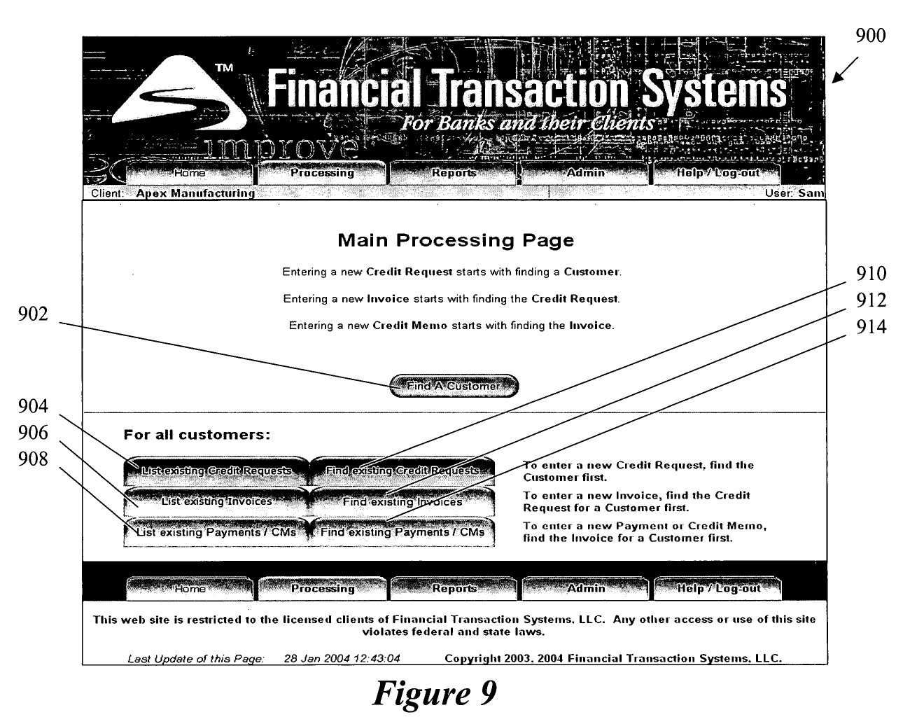

As shown in FIG. 8, functional tabs such as “Home” 804, “Processing” 806, “Reports” 808, “Admin” 810, and “Help/Log-Out” 812 can provide access to one or more subsequent webpages associated with one or more corresponding functions. For example, user selection of functional tab “Home” 804 can cause the display of webpage 800 and associated functionality shown in FIG. 8. In another example, user selection of functional tab “Processing” 806 can cause the display of a webpage 900 and associated processing-type functionality shown in FIG. 9, such as finding, entering or changing customer-related information, credit requests, invoices, and credit memos. In yet another example, user selection of functional tab “Reports” 808 can cause the display of another webpage with associated reporting-type functionality such as reporting on some or all aspects of a trade credit transaction. In yet another example, user selection of functional tab “Admin” 810 can cause the display of another webpage with associated administrative-type functionality such as adding or changing permissions for users, and company information associated with users. In a further example, user selection of functional tab “Help/Log Out” 812 can cause the display of another webpage with associated help and/or log-out-type functionality, such as information on using the system, obtaining technical support, or logging out from the system. To assist a user's navigation of a series of one or more associated webpages, one or more of the functional tabs such as 804, 806, 808, 810, 812 can remain visible and accessible to the user throughout some or all of a series of one or more webpages. Fewer or greater functional tabs can exist on a webpage according to other embodiments of the invention.

In addition, as shown in FIG. 8, one or more command buttons such as “Find a Customer” 814 can provide access to one or more subsequent webpages associated with one or more corresponding functions. For example, user selection of the command button “Find a Customer” 814 can initiate a particular command or series of related commands and/or functions, such as finding a transaction record for a particular customer or seller. In at least one embodiment, a portion of an overview webpage such as 800 can provide a “Quick Links” section 816 with one or more command buttons such as 814 to provide relatively direct access to frequently used features. Fewer or greater command buttons can exist on a webpage according to other embodiments of the invention.

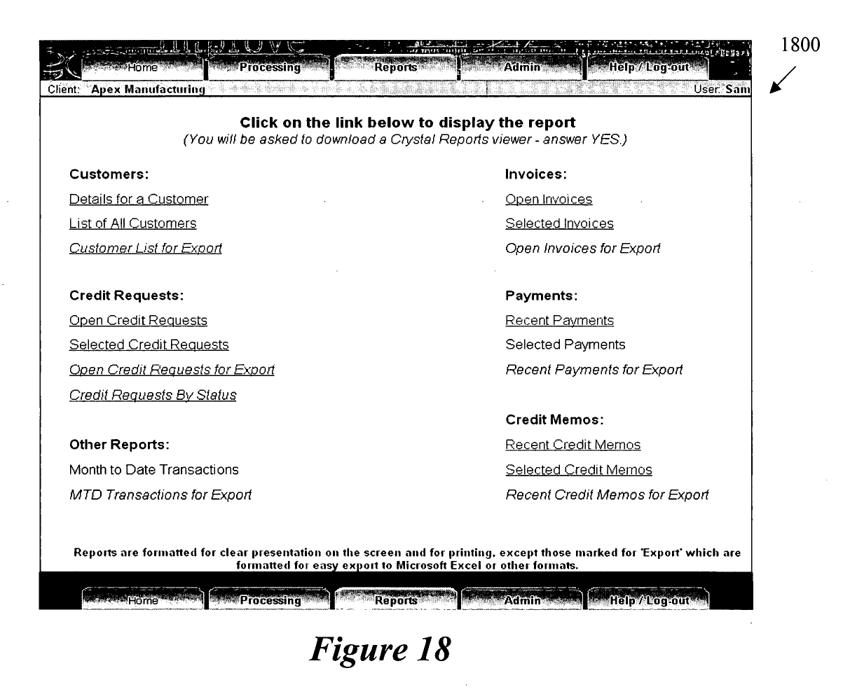

The webpage 800 shown in FIG. 8 can provide or otherwise facilitate functionality for a user to transmit a request for approval of a purchase using trade credit. For example, by selecting a functional tab “Processing” 806 on webpage 800, a user 202a can access processing-type functionality shown in FIG. 8, such as initiating a request for approval of a purchase using trade credit. In another example, selecting a functional tab such as “Reports” 808 on webpage 800, a user 202a can access reporting-type functionality shown in FIG. 18, such as generating one or more reports including data associated with a trade credit transaction.

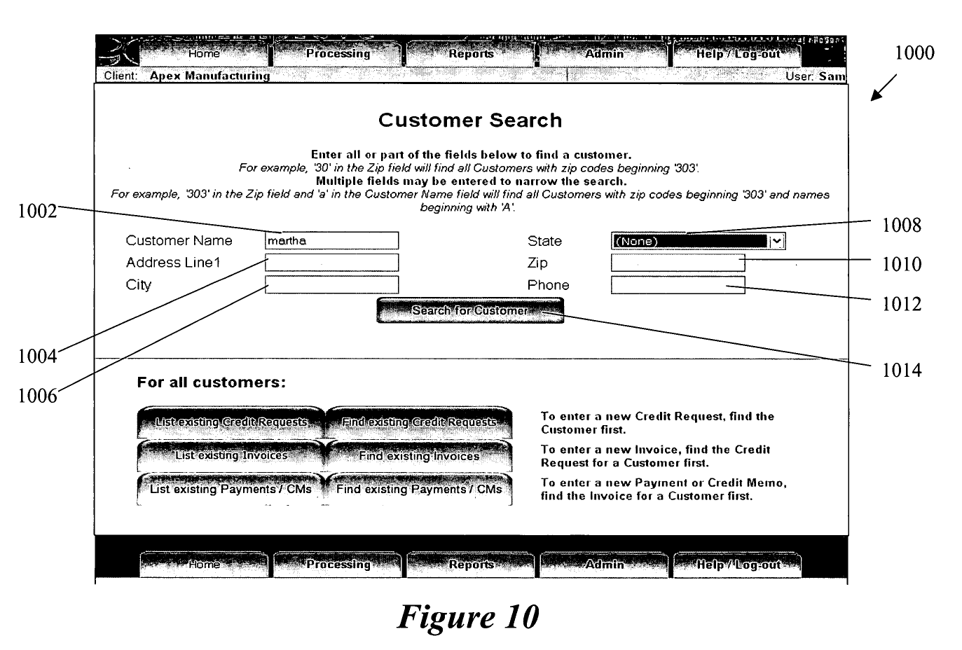

In particular, FIGS. 9-17 illustrate example screenshots for a user interface with processing-type functionality for an embodiment of an automated trade credit processing application engine. As shown in FIG. 9, a main processing page webpage 900 with one or more command buttons such as “Find a Customer” 902 and/or functional tabs 904, 906, 908, 910, 912, 914 can provide processing-type functionality. For example, a user such as 202a can operate an associated client device 202 to select the command button “Find a Customer” 902 to initiate a request for approval of a purchase using trade credit. Upon selection of the command button “Find a Customer” 902, a subsequent webpage such as 1000 in FIG. 10 can be displayed. Fewer or greater command buttons can exist on a webpage according to other embodiments of the invention.

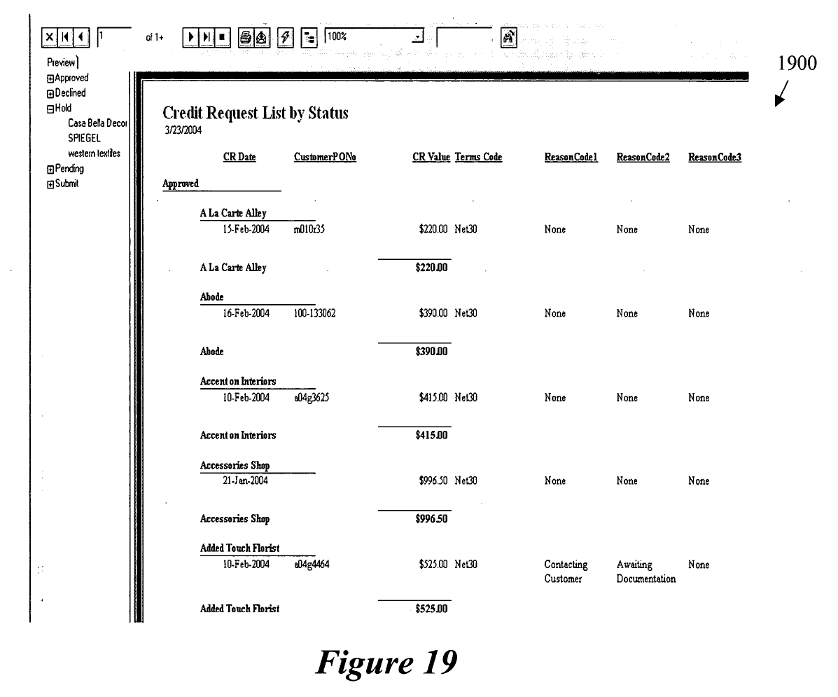

One or more functional tabs such as “List existing credit requests” 904, “List existing invoices” 906, “List existing payments/CM's” 908, “Find existing credit requests” 910, and “Find existing payments/CM's” 912 can provide access to one or more subsequent webpages associated with one or more corresponding functions. For example, user selection of functional tab “List existing credit requests” 904 can cause the display of webpage 1900 and associated functionality shown in FIG. 19. In another example, user selection of functional tab “List existing invoices” 906 can cause the display of a webpage with a list of invoices associated with a particular seller, and can also cause the display of associated functionality. In yet another example, user selection of functional tab “Find existing credit requests” 910 can cause the display of another webpage with a search window for entering a query to find a particular credit request, and can also cause the display as associated functionality. In yet another example, user selection of functional tab “Find existing payments/CM's” 912 can cause the display of another webpage with a search window for entering a query to find a particular payment, and can also cause the display of associated functionality. To assist a user's navigation of a series of one or more associated webpages, one or more of the functional tabs such as 904, 906, 908, 910, 912, 914 can remain visible and accessible to the user throughout some or all of a series of one or more webpages. Fewer or greater functional tabs can exist on a webpage according to other embodiments of the invention.

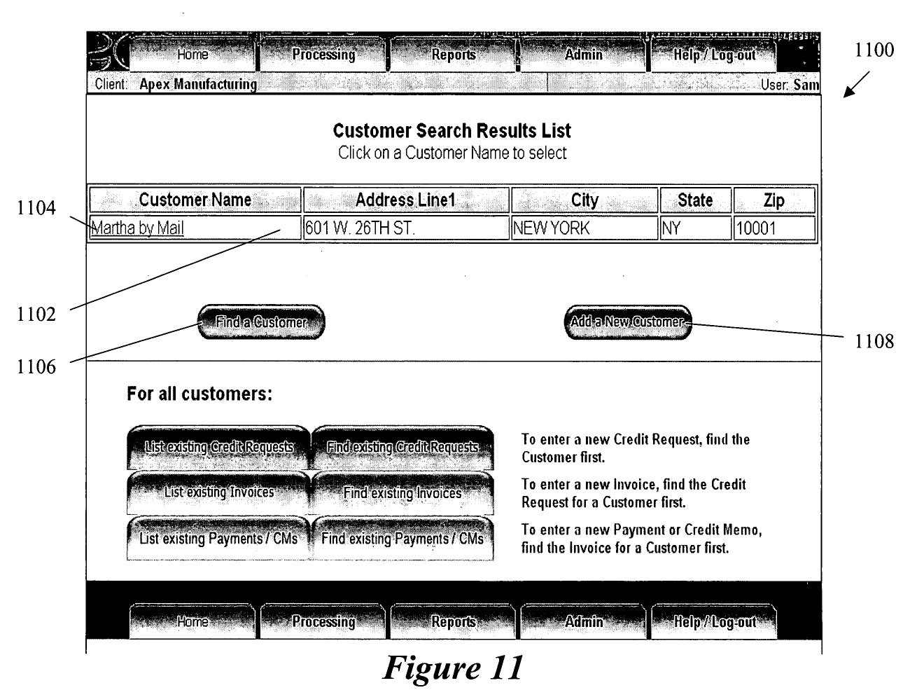

In FIG. 10, a webpage with processing-type functionality is illustrated. As shown in FIG. 10, a customer search webpage 1000 with one or more search fields such as “Customer Name” 1002, “Address Line 1” 1004, “City” 1006, “State” 1008, “Zip” 1010, and “Phone” 1012 can receive user input for customer or buyer-related data to be searched. Continuing from an example in FIG. 10, a user 202a associated with a seller 102 desiring to search for a customer such as “Martha By Mail” can input query data such as “martha” into the data field “Customer Name” 1002. Other query data can be input into other corresponding data fields 1004, 1006, 1008, 1010, 1012 if known, and all such data can be utilized by the automated trade credit processing application engine 220 to search for a particular customer record. In subsequent FIGS. 11-17, described below, the user can continue to utilize the user interface to initiate a request for approval of a trade credit transaction for a customer such as “Martha by Mail.”

On or more command buttons such as “Search a Customer” 1014 can provide processing-type functionality. For example, a user such as 202a can operate an associated client device 202 to select the command button “Search a Customer” 1014 to further initiate a request for approval of a purchase using trade credit. Following from the example above, upon user selection of the command button “Search a Customer” 1014, a subsequent webpage such as 1100 in FIG. 11 can be displayed including any corresponding search results for any query data provided, such as for the query “martha”. Fewer or greater command buttons can exist on a webpage according to other embodiments of the invention.

In FIG. 11, a webpage with processing-type functionality is illustrated. As shown in FIG. 11, a customer search results list webpage 1100 can display one or more search results such as 1102. The search results can be shown in response to any query data provided by a user. If for example, there are no search results in response to a particular query, the user can input a new query, otherwise modify the query and search again for a particular customer or buyer, or insert a new customer into the database. Continuing from the example provided above, in response to query data such as “martha,” the automated trade credit processing application engine 220 can obtain and display search results such as “Martha by Mail” 1102. In the example shown in FIG. 11, a search result “Martha by Mail” 1102 can be displayed including associated customer-related information such as, but not limited to, the customer name, address line 1, city, state, and zip code. In one embodiment, some or all of the search result can be highlighted or otherwise indicated as a link to additional information. In the example shown in FIG. 11, the customer name portion such as “Martha by Mail” 1102 can be highlighted or otherwise indicated as a link 1104 for a user to select to obtain additional associated customer-related information in one or more subsequent webpages. Fewer or greater links or other indications can exist on a webpage depending on the number of search results and further according to other embodiments of the invention.

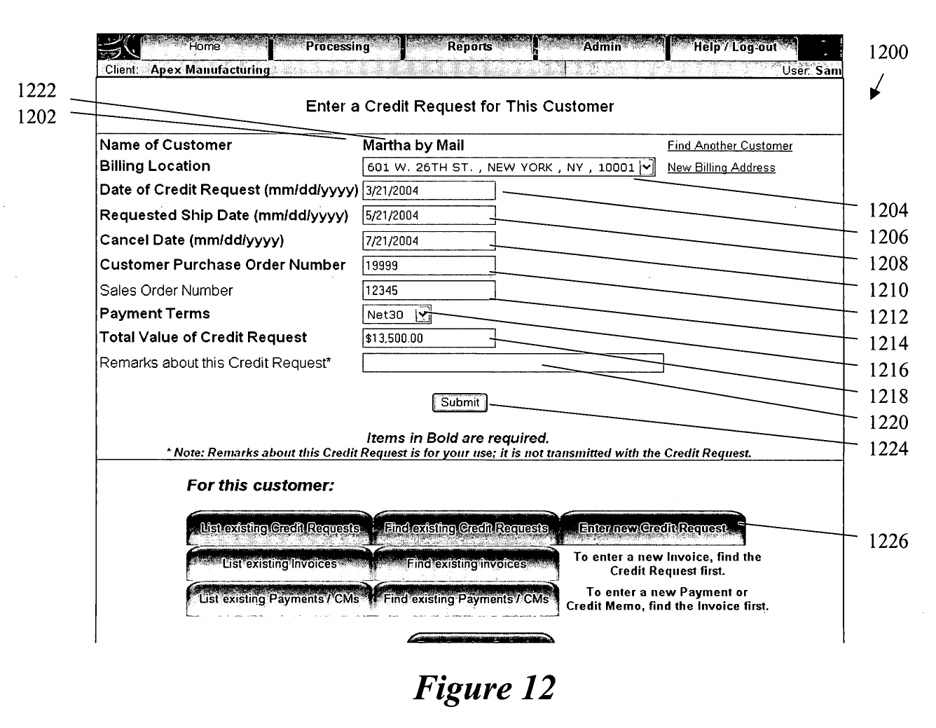

One or more command buttons such as “Find a Customer” 1106 and “Add a New Customer” 1108 can provide additional processing-type functionality. For example, a user such as 202a can operate an associated client device 202 to select the command button “Find a Customer” 1106 to initiate another search for a customer. In some instances, the user 202a may decide to add a new customer if a particular search result or search query does not return a desired customer record, or if the customer is a new customer. In these instances, a user 202a may select the command button “Add a New Customer” 1108 to initiate adding a customer or buyer record. Following from the example above, upon user selection of the link “Martha by Mail” 1104 in search result 1102, a subsequent webpage such as 1200 in FIG. 12 can be displayed including any preexisting or previously entered data associated with the particular customer or buyer. Fewer or greater command buttons can exist on a webpage according to other embodiments of the invention.

In FIG. 12, a webpage with processing-type functionality is illustrated. As shown in FIG. 12, a credit request entry webpage 1200 can display one or more data fields for entry of customer or buyer-related information by a user. Continuing from the example provided above, in response to the user's selection of a link 1104 associated with “Martha by Mail,” the automated trade credit processing application engine 220 can obtain and display preexisting or previously stored data in one or more data fields such as “Name of Customer” 1202. The user 202a can proceed to enter customer-related and credit request-related data into some or all of the corresponding data fields. In the example shown in FIG. 12, other data fields can be displayed including, but not limited to, “Billing Location” 1204, “Date of Credit Request” 1206, “Requested Shipping Date” 1208, “Cancel Date” 1210, “Customer Purchase Order” 1212, “Sales Order Number” 1214, “Payment Terms” 1216, “Total Value of Credit Request” 1218, and “Remarks about this Credit Request” 1220. In the example shown in FIG. 12, the name of the customer, “Martha by Mail” 1222, can be inserted by the automated trade credit processing application engine 220 into the corresponding data field “Name of Customer” 1202. Other data fields 1204, 1206, 1208, 1210, 1212, 1214, 1216, 1218, 1220 can be populated with available information by the automated trade credit processing application engine 220. As needed, a user such as 202a can input, delete, or otherwise modify customer-related and/or credit request-related data in one or more of the data fields 1204, 1206, 1208, 1210, 1212, 1214, 1216, 1218, 1220. Some or all of the data can then be processed as a request for a trade credit transaction by the automated trade credit processing application engine 220, and stored for subsequent retrieval. Fewer or greater data fields can exist on a webpage according to other embodiments of the invention.

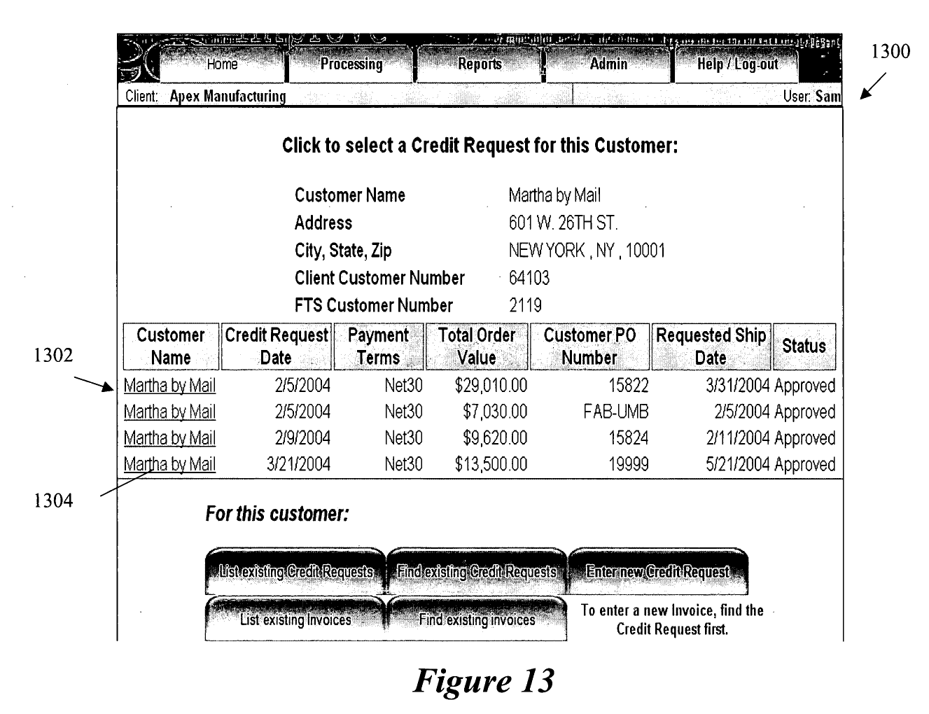

One or more command buttons such as “Submit” 1224 can provide processing-type functionality. For example, a user such as 202a can operate an associated client device 202 to select the command button “Submit” 1224 to submit the associated customer or buyer-related information for processing as a request for a trade credit transaction. Fewer or greater command buttons can exist on a webpage according to other embodiments of the invention Continuing from the example above, upon a user's review and input, if needed, of customer or buyer-related data into some or all of the data fields 1202, 1204, 1206, 1208, 1210, 1212, 1214, 1216, 1218, 1220, the user 202a can select the command button “Submit” 1224. The automated trade credit processing application engine 220 can receive the data for processing as a request for a trade credit transaction, and can store the data for subsequent retrieval. The automated trade credit processing application engine 220 can then display a subsequent webpage such as 1300 in FIG. 13.

In the example shown in FIG. 12, one or more functional tabs can provide processing-type functionality. For example, a user such as 202a can operate an associated client device 202 to select the functional tab “Enter a new Credit Request” 1226. to initiate a new request for approval of a purchase using trade credit. Upon selection of the functional tab “Enter a new Credit Request” 1226, a subsequent webpage can be displayed in order to initiate a new request for approval of a purchase using trade credit. Fewer or greater command buttons can exist on a webpage according to other embodiments of the invention.

In FIG. 13, a webpage with processing-type functionality is illustrated. As shown in FIG. 13, a credit request status by customer webpage 1300 can display one or more credit requests for a particular customer or buyer. Continuing from the example provided above, in response to the user's review and submission of customer-related and credit request-related information, the automated trade credit processing application engine 220 can grant or deny a request for a trade credit transaction. The automated trade credit processing application engine 220 can notify the user 202a via the webpage 1300, such as by displaying data associated with the particular credit request, including any preexisting or previously stored credit requests for a particular customer, such as “Martha by Mail. In the example shown in FIG. 13, a total of four credit requests 1302 are shown including related information such as customer name, credit request date, payment terms, total order value, customer PO number, requested ship date, and status. Other customer-related and credit request-related information can be displayed including, but not limited to, the customer name, address, city, state, zip code, client customer number, and internal (FTS) customer number. The status of processing of a credit request by the automated trade credit processing application engine 220 can be shown as “Approved,” “Pending,” or “Denied.” The credit request from the example above is shown as “Approved” and is the credit request entry at the end of the list shown in FIG. 13. Fewer or greater credit requests as well as related information can exist on a webpage according to other embodiments of the invention.

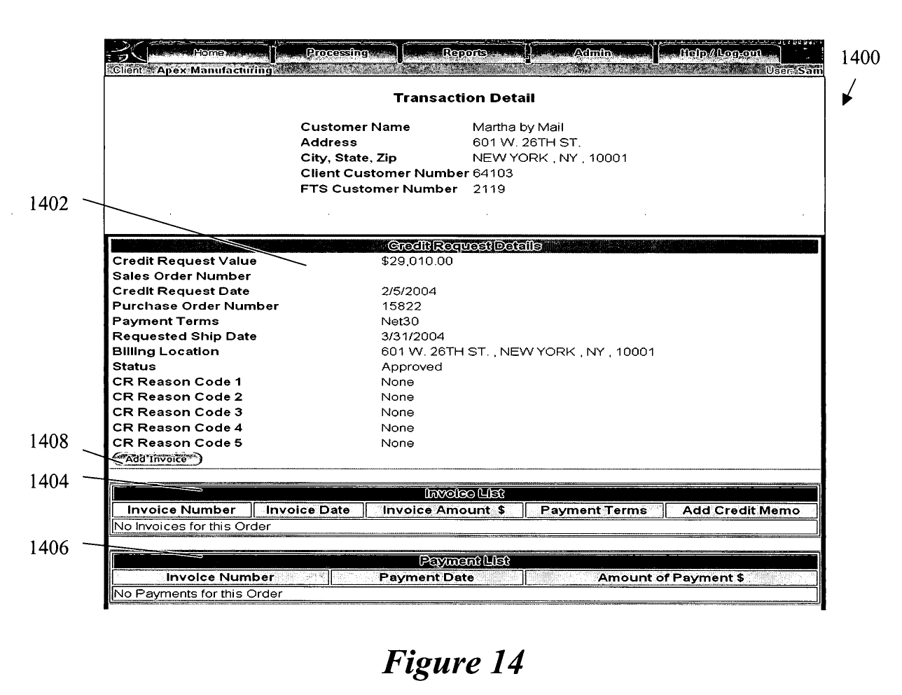

Similar to the link example above, some or all of the credit requests can be highlighted or otherwise indicated as a link to additional information. In the example shown in FIG. 13, the customer name portion such as “Martha by Mail” 1304 can be indicated as a link for a user to select to obtain additional associated information for each credit request or customer-related information in one or more subsequent webpages, such as 1400 in FIG. 14. Fewer or greater links or other indications can exist on a webpage depending on the number of search results and further according to other embodiments of the invention.

In FIG. 14, a webpage with processing-type functionality is illustrated. As shown in FIG. 14, a transaction detail webpage 1400 can display credit request-related information for a particular credit request. Continuing from the example provided above, in response to a user's selection of a particular credit request, such as 1304, the automated trade credit processing application engine 220 can obtain and display preexisting or previously stored credit request-related information for a particular credit request in a credit request details field 1402. In the example shown in FIG. 14, credit request-related information can be displayed in field 1402, such as credit request value, sales order number, credit request date, purchase order (PO) number, payment terms, requested ship date, billing location, status, and CR reason code 1-5. Other credit request-related information can be displayed including, but not limited to, the customer name, address, city, state, zip code, client customer number, and internal (FTS) customer number. Some or all of the credit request-related information can exist on a webpage according to other embodiments of the invention.

Other fields such as an invoice list 1404 and a payment 1406 list can be utilized by the automated trade credit processing application engine 220 to display any invoice and payment information related to the particular transaction shown in field 1402. Credit request-related information that can be shown in the invoice list 1404 can include invoice number, invoice date, invoice amount, payment terms, and add credit memo. Credit request-related information that can be shown in the payment list 1406 can include, but is not limited to, invoice number, payment date, and amount of payment. If no invoices or payments exist for a particular transaction, then an indication such as “No invoices for this order,” and/or “No payments for this order” can be displayed accordingly.

Similar to the link example above, some or all of the credit requests can be highlighted or otherwise indicated as a link to additional information. In the example shown in FIG. 13, the customer name portion such as “Martha by Mail” 1304 can be indicated as a link for a user to select to obtain additional associated information for each credit request in one or more subsequent webpages, such as 1400 in FIG. 14. Fewer or greater links or other indications can exist on a webpage depending on the number of search results and further according to other embodiments of the invention.

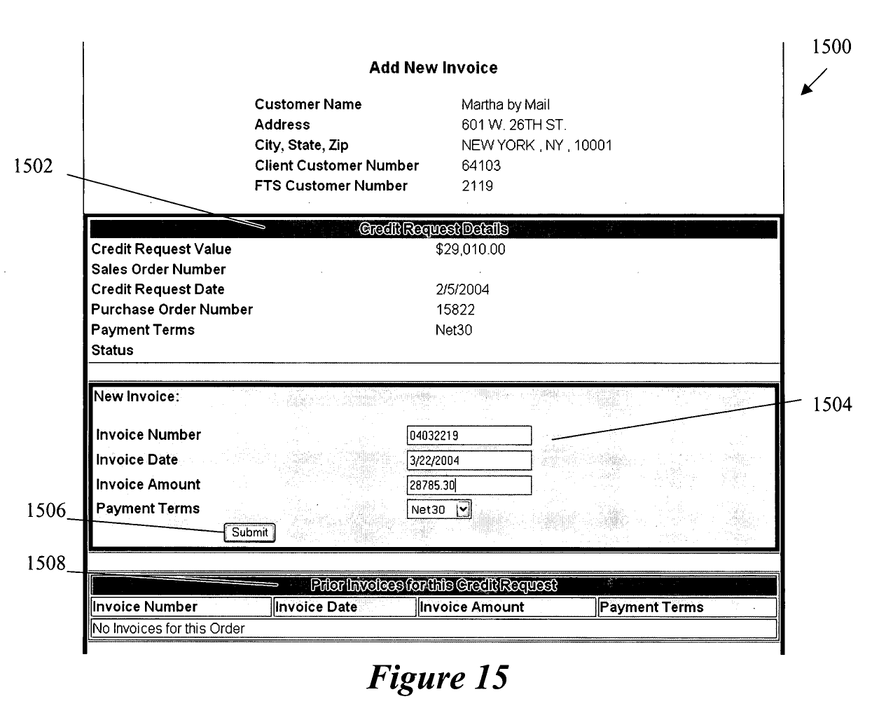

One or more command buttons such as “Add Invoice” 1408 can provide processing-type functionality. For example, a user such as 202a can operate an associated client device 202 to select the command button “Add Invoice” 1408 to initiate an invoice for a particular transaction. Continuing from the example above, upon approval of a particular credit request for a customer such as “Martha by Mail,” the user 202a can select the command button “Add Invoice” 1408, and a subsequent webpage such as 1500 in FIG. 15 can be displayed. Fewer or greater command buttons can exist on a webpage according to other embodiments of the invention.

In FIG. 15, a webpage with processing-type functionality is illustrated. As shown in FIG. 15, an add new invoice webpage 1500 can display customer-related and credit request-related information for a particular credit request and provide data input fields for a new invoice associated with the credit request or purchase. A user can add invoice-related data such as, but not limited to, invoice number, invoice date, invoice amount, and payment terms. In the example shown in FIG. 15, credit request-related information can be displayed in field 1502, including but not limited to, credit request value, sales order number, credit request date, purchase order (PO) number, payment terms, and status. Other credit request-related information can be displayed including, but not limited to, the customer name, address, city, state, zip code, client customer number, and internal (FTS) customer number. Some or all of the credit request-related and invoice-related information can exist on a webpage according to other embodiments of the invention.

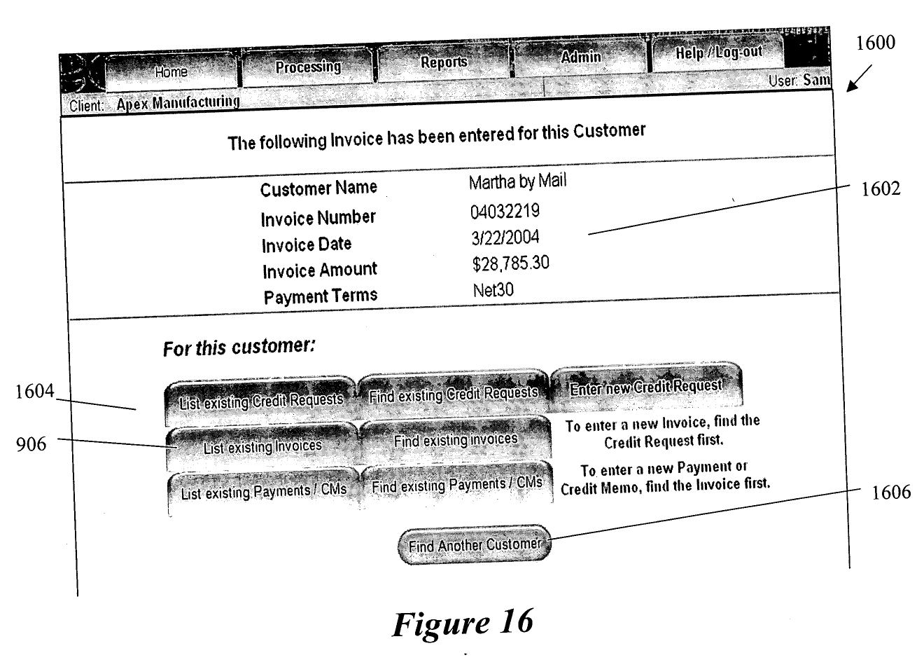

Continuing from the example provided above, in response to a user's selection of the command button “Add Invoice” 1408, the automated trade credit processing application engine 220 can obtain and display preexisting or previously stored customer-related and credit request-related information for a particular credit request in a details field 1502. The user 202a can add invoice-related data for a particular purchase associated with the credit request, such as invoice number, invoice date, invoice amount, and payment terms. For example, in an adjacent field 1504, one or more data fields can be provided for entry of invoice-related data such as invoice number, invoice date, invoice amount, and payment terms. When a user 220a has completed some of all of the data fields, the user 202a can select a command button such as “Submit” 1506 to transmit the invoice-related data to the automated trade credit processing application engine 220 for subsequent processing and storage. Following the submission of the invoice-related data, a subsequent webpage such as 1600 in FIG. 16 can be displayed.

In another adjacent field 1508, prior invoices to the particular credit request indicated in field 1502 can be displayed. Prior invoice-related information can include, but is not limited to, invoice number, invoice date, invoice amount, and payment terms. If no prior invoices exist for a particular credit request, then an indication such as “No invoices for this order” can be displayed accordingly.

In FIG. 16, a webpage with processing-type functionality is illustrated. As shown in FIG. 16, an invoice confirmation webpage 1600 can display transaction-related information for a particular credit request and provide data input fields for a new invoice. Continuing from the example provided above, in response to a user's submission of invoice-related data, the automated trade credit processing application engine 220 can display the invoice-related information for a particular credit request by a customer or buyer indicated in a field 1602. In the example shown in FIG. 16, invoice-related information can be displayed in field 1602, such as customer name, invoice number, invoice date, invoice amount, and payment terms. Some or all of the invoice-related information can exist on a webpage according to other embodiments of the invention.

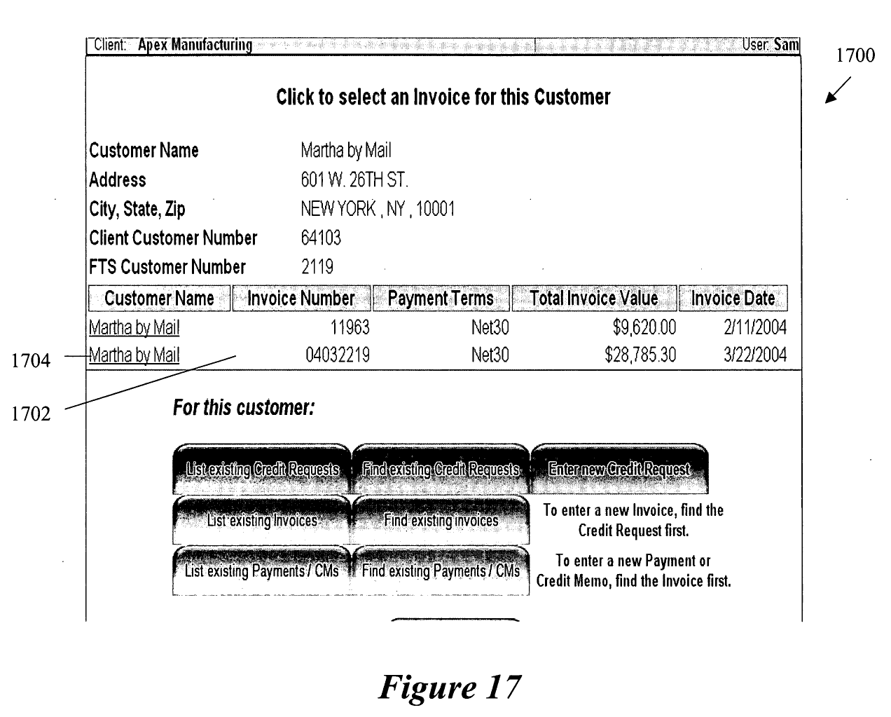

In an adjacent field 1604, one or more functional tabs as previously described above, such as 904, 906, 908, 910, 912, 914, 1226, can be displayed for a user to access additional processing-type functionality. If for example, a user 202a selects functional tab “List existing invoices” 906, then the automated trade credit processing application engine 220 can display some or all invoices related to the particular customer indicated in field 1602. An example of a list of invoices is shown on webpage 1700 in FIG. 17. Fewer or greater functional tabs can exist on a webpage according to other embodiments of the invention.

One or more command buttons such as “Find Another Customer” 1606 can provide additional processing-type functionality. For example, a user such as 202a can operate an associated client device 202 to select the command button “Find Another Customer” 1606 to find a transaction record for a particular customer or seller. Examples of user interfaces associated with finding a customer are described above. Fewer or greater command buttons can exist on a webpage according to other embodiments of the invention.

In FIG. 17, a webpage with processing-type functionality is illustrated. As shown in FIG. 17, an invoice list webpage 1700 can display a list of invoices for a particular customer and provide invoice-related data for each invoice shown. If for example, a particular invoice has been paid or satisfied, an indication can be displayed showing the invoice as “Closed.” Continuing from the example provided above, in response to a user's request for a list of invoices for a particular customer, the automated trade credit processing application engine 220 can display in field 1702 a list of invoices with invoice-related information for a particular customer or buyer such as “Martha by Mail.” In the example shown in FIG. 17, invoice-related information can include customer name, invoice number, invoice date, payment terms, and total invoice value. Some or all of the numbers of invoices and invoice-related information can exist on a webpage depending on the customer, and further according to other embodiments of the invention.

Similar to the link examples above, some or all of the invoices can be highlighted or otherwise indicated as a link to additional information. In the example shown in FIG. 17, the customer name portion such as “Martha by Mail” 1704 can be indicated as a link for a user to select to obtain additional associated information for each invoice in one or more previous or subsequent webpages. Fewer or greater links or other indications can exist on a webpage depending on the number of search results and further according to other embodiments of the invention.

FIGS. 18-21 illustrate examples of screenshots for a user interface with reporting-type functionality for an embodiment of an automated trade credit processing application engine. In FIG. 18, a webpage with reporting-type functionality is illustrated. As shown in FIG. 18, a menu webpage 1800 can display a list of reports for a user to view and/or generate, and provide transaction-related data for the user. In the example shown in FIG. 18, reports can include, but are not limited to, details for a customer, list of all customers, customer list for export, open credit requests, selected credit requests, open credit requests for export, credit requests by status, month-to-date (MTD) transactions, MTD transactions for export, open invoices, selected invoices, open invoices for export, recent payments, selected payments, recent payments for export, recent credit memos, selected credit memos, and recent credit memos for export. The webpage 1800 can be customized as needed with greater or fewer links to these and other reports. Reports can be formatted in a suitable application program format prior to exporting to another application program and/or processing platform. Examples of suitable formats include, but are not limited to, CrystaI™ reports (.rpt), Microsoft Word™ (.doc), Microsoft Excel™ (.xls), Rich Text Format (.rtf), and Adobe Acrobat™ (.pdf). Fewer or greater reports providing transaction-related information can exist on a webpage depending on the customer, and further according to other embodiments of the invention.

In FIG. 19, a webpage with reporting-type functionality is illustrated. As shown in FIG. 19, a credit request list webpage 1900 can display a report of some or all credit requests by status for a user to view. In the example shown in FIG. 18, a credit request list status report can include, but is not limited to, a credit request (CR) date, customer purchase order (PO) number, CR value, terms code, reason codes 1-3, customer name, and a status. Some or all of the reporting information can exist on a webpage depending on the number of search results and further according to other embodiments of the invention.

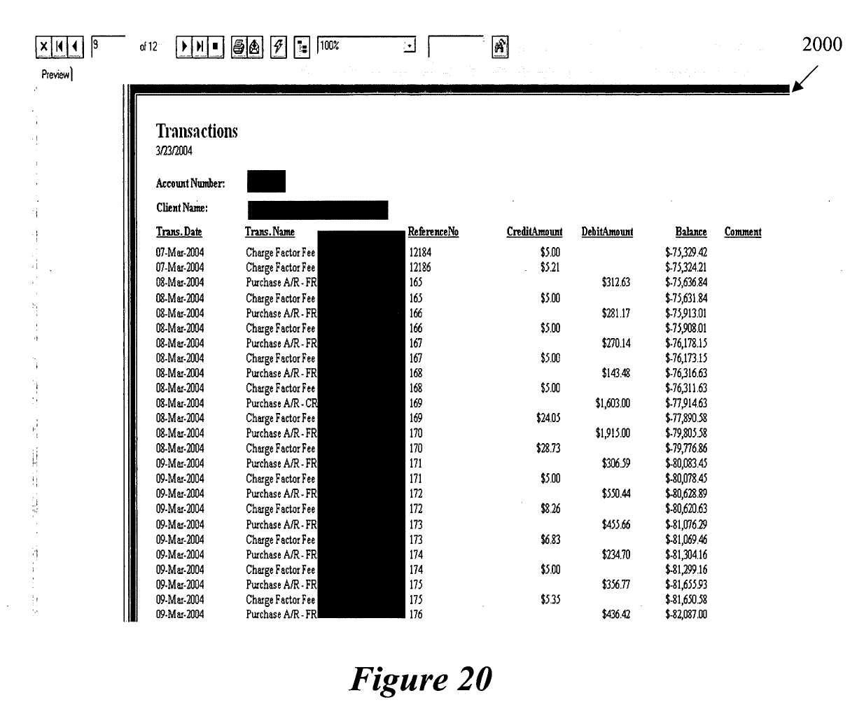

In FIG. 20, a webpage with reporting-type functionality is illustrated. As shown in FIG. 20, a transaction report webpage 2000 can display a report of some or all transactions by client or seller for a user to view. In the example shown in FIG. 20, a transaction list report can include, but is not limited to, an account number, client or seller name, transaction date, transaction name, reference number, credit amount, debit amount, balance, and comment. Some or all of the reporting information can exist on a webpage according to other embodiments of the invention.

In at least one embodiment, reports can be displayed by the user interface in a unique double accounting-type entry format that can be presented from the particular point of view of that entity. In the example shown in FIG. 20, the user interface or webpage 2000 shows a double accounting-type entry format for at least one transaction including credit amounts and debit amounts from the individual point of view of the user. Since trade credit transactions can involve several entities, this type of format is useful for viewing and analyzing data. Other accounting-type formats for reporting data, and other views of accounting data, can be utilized or otherwise facilitated by other embodiments of the invention.

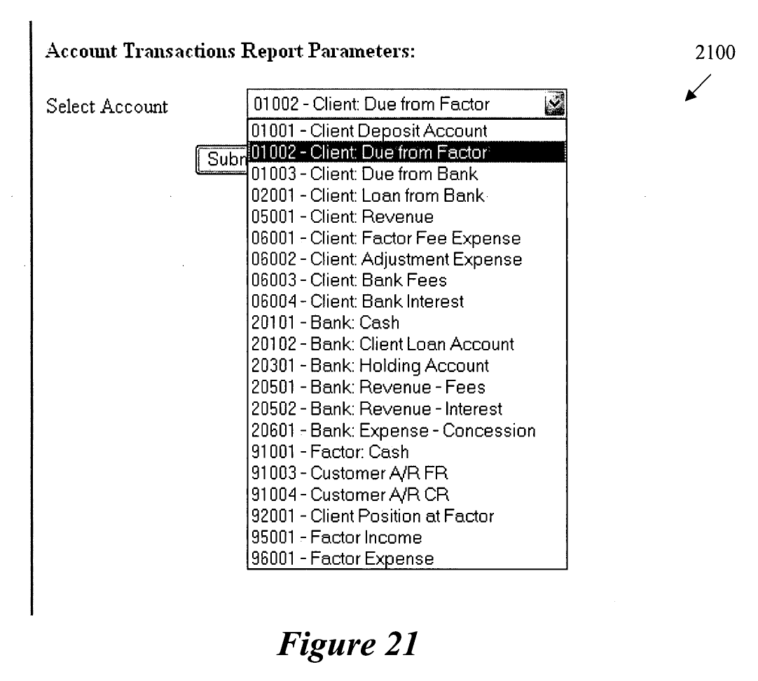

In FIG. 21, a menu for webpage with reporting-type functionality is illustrated. As shown in FIG. 21, a report parameter menu 2100 can display some or all transaction report parameters for a user to view and select. In the example shown in FIG. 21, a report parameter menu can include reports including, but is not limited to, client or seller-related data, customer or buyer-related data, bank or customer sponsor-related data, bank or seller sponsor-related data, and other transaction data. In one embodiment, a particular user may desire to view data from his or her own perspective, such as from a seller (client) perspective. Other views can be provided such as from a seller sponsor (bank) or customer sponsor perspective. Using the menu 2100, a user can select a particular selection to view the data from a particular perspective such as from a seller's perspective, i.e. “01002—Client: Due from Factor.” Fewer or greater menu parameters can exist on a menu according to other embodiments of the invention.

FIGS. 22-35 illustrate examples of screenshots for a financial transaction website interface for a user, such as a user associated with a seller sponsor, bank, or other financial institution. For example in FIG. 22, a user 210a operating an associated client device 210 can access a user interface such as a bank overview webpage 2200 via network 214. The bank overview webpage 2200 can be customized for the user 210a, such as a bank or seller sponsor 102, for example “Wall Financial Services” 2202. Using a mouse or other input device associated with the client device 210, the user 210a can select a functional tab 2204, 2206, 2208, 2210, 2212 and/or link 2214 corresponding to one or more subsequent webpages associated with one or more corresponding functions.

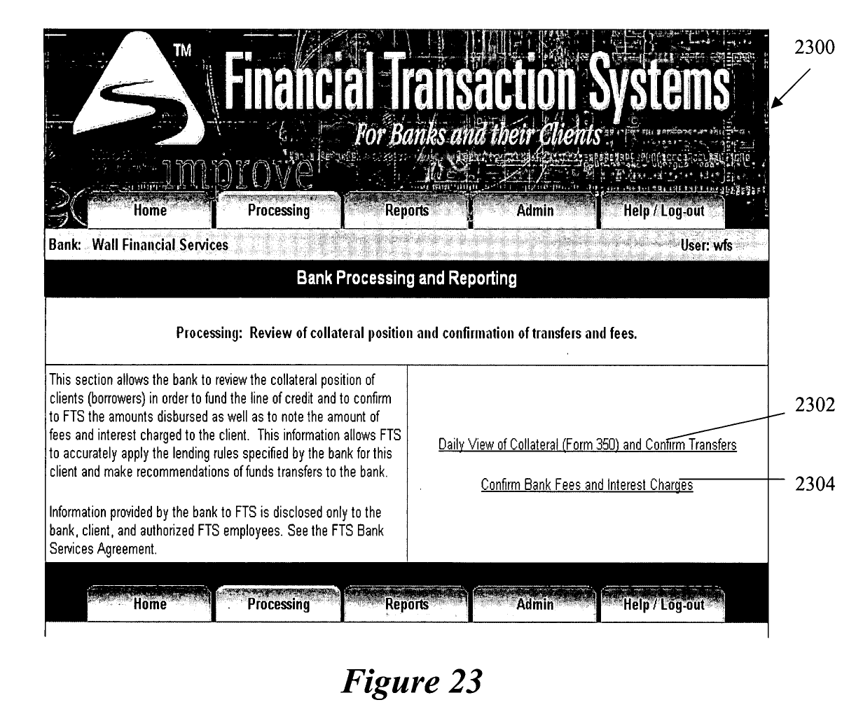

As shown in FIG. 22, functional tabs such as “Home” 2204, “Processing” 2206, “Reports” 2208, “Admin” 2210, and “Help/Log-Out” 2212 can provide access to one or more subsequent webpages associated with one or more corresponding functions. For example, user selection of functional tab “Home” 2204 can cause the display of webpage 2200 and associated functionality shown in FIG. 22. In another example, user selection of functional tab “Processing” 2206 can cause the display of a webpage 2300 and associated processing functionality shown in FIG. 23, such as viewing the status of collateral and loan positions for a seller. In yet another example, user selection of functional tab “Reports” 2208 can cause the display of another webpage with associated reporting-type functionality, such as reports for each seller and overall position. In yet another example, user selection of functional tab “Admin” 2210 can cause the display of another webpage with associated administrative-type functionality, such as administration of sellers and bank users. In a further example, user selection of functional tab “Help/Log Out” 2212 can cause the display of another webpage with associated help and/or log-out-type functionality, such as assistance in using the system and technical support information. To assist a user's navigation of a series of one or more associated webpages, one or more of the functional tabs such as 2204, 2206, 2208, 2210, 2212 can remain visible and accessible to the user throughout some or all of a series of one or more webpages. Fewer or greater functional tabs can exist on a webpage according to other embodiments of the invention.

In addition, as shown in FIG. 22, one or more links such as “Form 350s” 2214 can provide access to one or more subsequent webpages associated with one or more corresponding functions. For example, user selection of the link “Form 350s” 2214 can initiate a particular command or series of related commands and/or functions, such as displaying a daily report of a particular client position or a form 350. In at least one embodiment, a portion of an overview webpage such as 2200 can provide a “Quick Links” section 2216 with one or more links and/or command buttons such as 2214 to provide relatively direct access to frequently used features. Fewer or greater command buttons can exist on a webpage according to other embodiments of the invention.

The webpage 2200 shown in FIG. 22 can provide or otherwise facilitate functionality for a user to manage and process collateral positions of one or more sellers, advances disbursed to sellers, and fees and interest charged to sellers. For example, by selecting link “Form 350s” 2214 a user 210a can obtain access to one or more subsequent webpages associated with one or more corresponding functions. For example, user selection of the link “Form 350s” 2214 can provide access to a particular command or series of related commands and/or functions, such as displaying a daily report of a particular client position or a form 350.

In particular, FIGS. 23-27 illustrate example screenshots for a user interface with processing-type functionality for an embodiment of an automated trade credit processing application engine. In FIG. 23, a webpage with processing-type functionality is illustrated. As shown in FIG. 23, a main processing page webpage 2300 with one or more links such as, but not limited to, “Daily View of Collateral (Form 350) and Confirm Transfers” 2302, and “Confirm Bank Fees and Interest Charges” 2304 can provide processing-type functionality. The webpage 2300 can be customized for a suer, including links to frequently accessed functionality such as 2302 and 2304. For example, a user such as 210a can operate an associated client device 210 to select the link “Daily View of Collateral (Form 350) and Confirm Transfers” 2302 to initiate functionality to select a particular seller and to view associated transaction-related data. Upon selection of the link “Daily View of Collateral (Form 350) and Confirm Transfers” 2302, a subsequent webpage such as 2500 in FIG. 25 can be displayed. Fewer or greater links can exist on a webpage according to other embodiments of the invention.

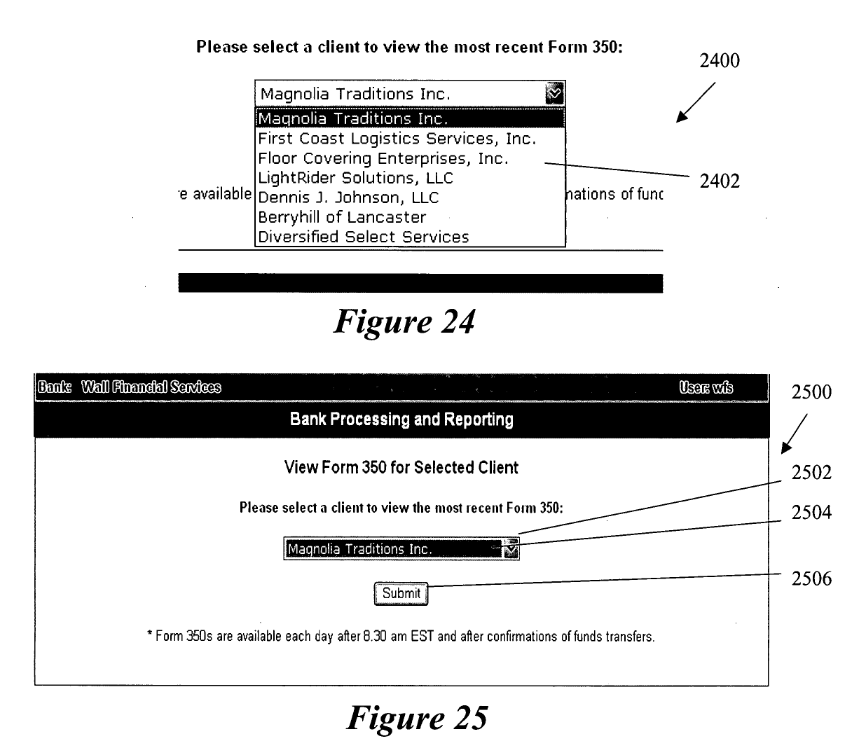

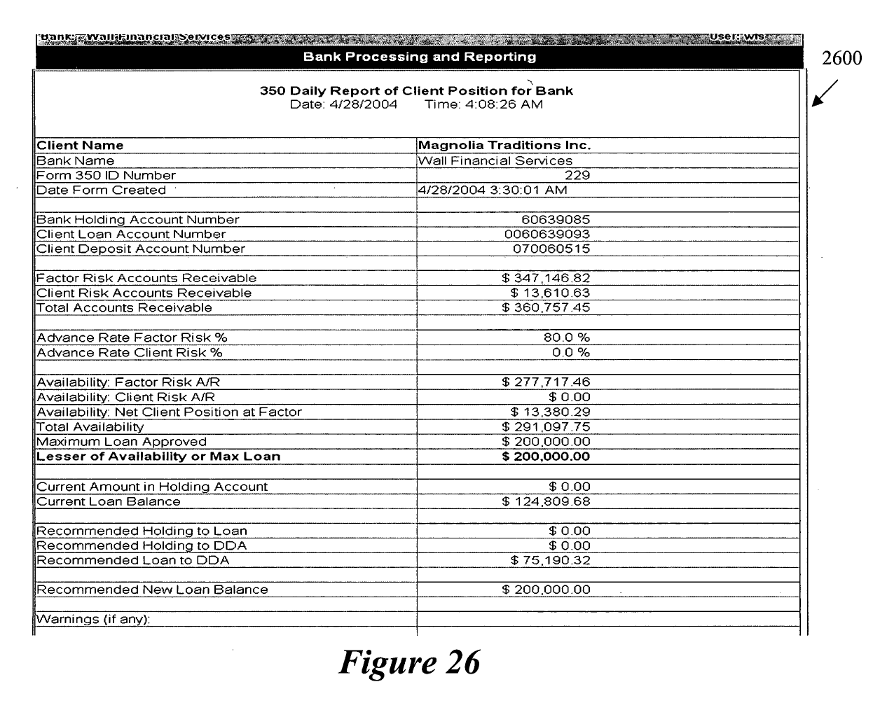

In FIGS. 24 and 25, a menu and webpage with processing-type functionality are illustrated. As shown in FIG. 25, a view form 350 webpage 2500 with a menu 2502 can provide processing-type functionality. For example, a user such as 210a can operate an associated client device 210 to select the menu 2502 to select a particular seller and to view associated transaction-related data. As shown in FIG. 24, an expanded menu 2402 with one or more sellers can be displayed for selection by the user 210a. Upon selection of a particular seller, such as “Magnolia Traditions, Inc.” 2504, the user 210a can select a command button such as “Submit” 2506 to transmit the selection to the automated trade credit processing application engine 220. A subsequent webpage such as 2600 in FIG. 26 can then be displayed. Some or all of the menus and menu selections can exist on a webpage according to other embodiments of the invention.

In FIG. 26, a webpage with processing-type functionality is illustrated. As shown in FIG. 26, a form 350 webpage 2600 can provide processing-type functionality. For example, a user such as 210a can view the form 350 webpage 2600 and obtain an overview of a collateral position of a seller sponsor or bank with respect to a particular seller. Information for the webpage 2600 can be updated as needed by the automated trade credit processing application engine 220. Furthermore, one or more lending rules and credit rules can be applied by the automated trade credit processing application engine 220 to obtain or otherwise derive information shown on the webpage 2600. The form 350 webpage 2600 can include collateral-related and other information such as, but not limited to, client or seller name, bank name, form 350 ID number, date form created, bank holding account number, client loan account number, client deposit account number, factor risk accounts receivable, client risk accounts receivable (A/R), total accounts receivable, advance rate factor risk percentage, advance rate client risk percentage, availability factor risk A/R, availability client risk A/R, amounts ineligible, reserves, availability net client position at factor, total availability, maximum loan approved, lesser of availability or max loan, current amount in holding account, current loan balance, recommended holding to loan, recommended holding to demand deposit account (DDA), recommended loan to DDA, recommended new loan balance, warnings (if any), and internal (FTS) account information, and other information determined by the interchange and the seller sponser. Some or all of the collateral-related and other information can utilize or otherwise facilitate one or more lending rules associated with a seller sponsor. Some or all of the collateral-related and other information can exist on a webpage according to other embodiments of the invention.

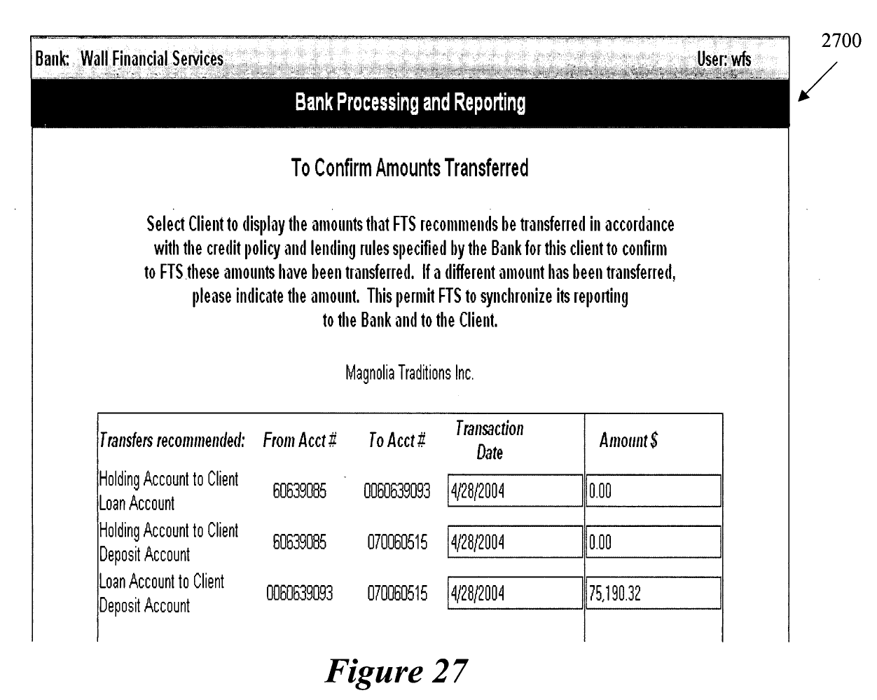

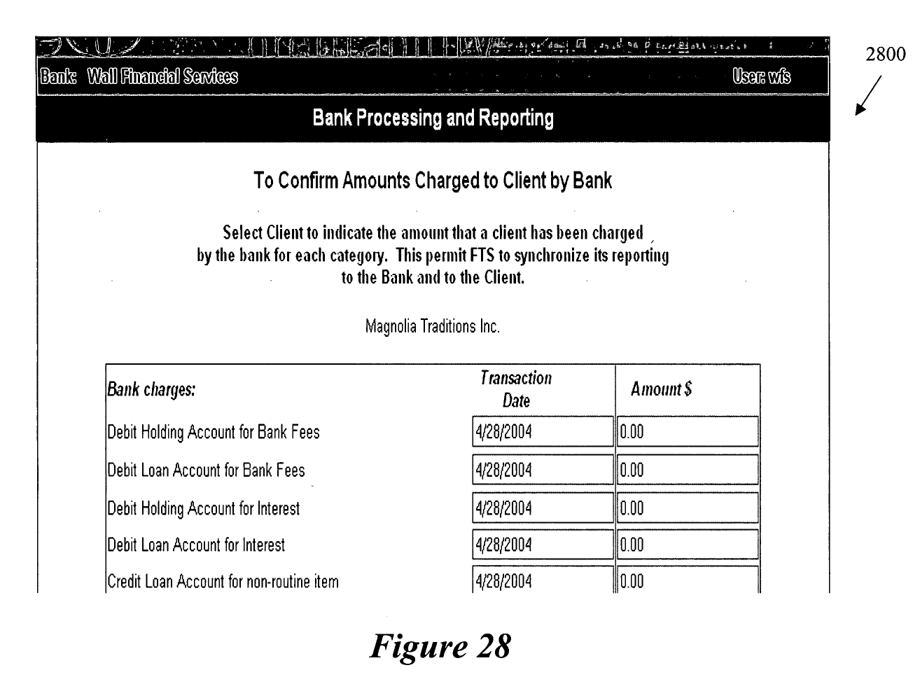

FIGS. 27 and 28 illustrate associated processing-type webpages accessible to a user such as seller sponsor or bank. In FIG. 27, a webpage with processing-type functionality is illustrated. As shown in FIG. 27, a transfer webpage 2700 can provide processing-type functionality. For example, a user such as 210a can confirm one or more amounts to be transferred to a seller, client, or other entity. In the example shown, the transfer webpage 2700 can display transfers from accounts, account numbers, transaction dates, and transfer amounts. In one embodiment, an automated trade credit processing application engine 220 can apply one or more lending rules to determine recommendations for transfer amounts, such as those shown on webpage 2700. When a seller sponsor 110 or bank performs a transfer of funds, the transferred amounts can be reported back to the automated trade credit processing application engine 220 and permit one or more accounts to be synchronized or otherwise modified accordingly.

In FIG. 28, a webpage with processing-type functionality is illustrated. As shown in FIG. 28, a charge webpage 2800 can provide processing-type functionality. For example, a user such as 210a can confirm one or more amounts to be charged to a seller, client, or other entity. In the example shown, the charge webpage 2800 can display bank charges, transaction dates, and charge amounts. In one embodiment, an automated trade credit processing application engine 220 can apply one or more credit rules to determine interest and bank fee amounts, such as those shown on webpage 2800. When a seller sponsor 110 or bank charges a seller such amounts, the amounts can be reported back to the automated trade credit processing application engine 220 and permit one or more accounts to be synchronized or otherwise modified accordingly.

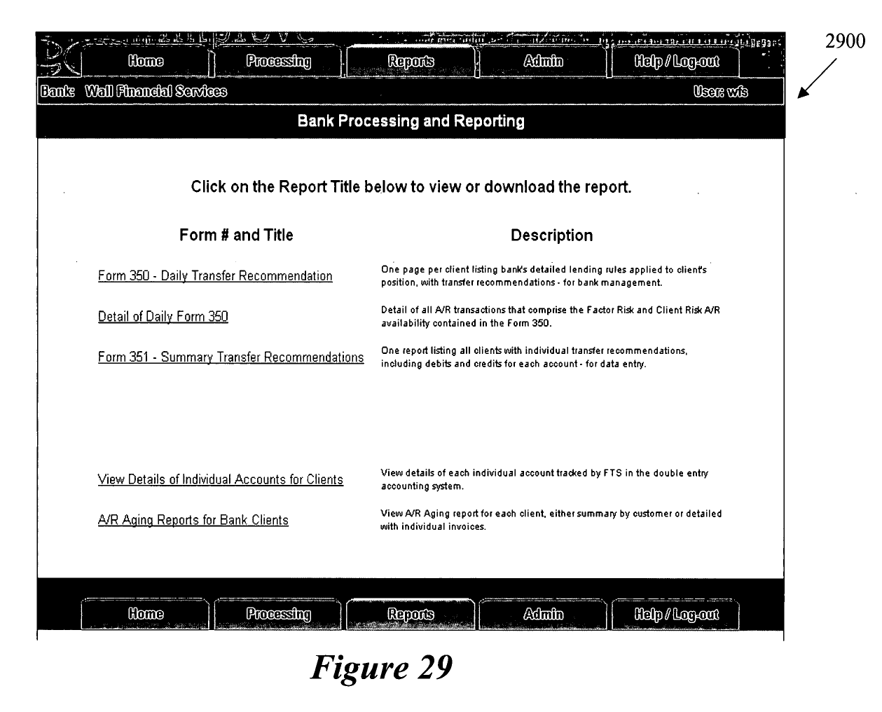

FIGS. 29-35 illustrate examples of screenshots for a user interface with reporting-type functionality for an embodiment of an automated trade credit processing application engine. In FIG. 29, a webpage with reporting-type functionality is illustrated. As shown in FIG. 29, a menu webpage 2900 can display a list of reports for a user to view and/or generate, and provide transaction-related data for the user. In the example shown in FIG. 29, reports can include, but are not limited to, form 350—daily transfer recommendation, detail of daily form 350, form 351—summary transfer recommendations, view details of individual accounts for clients, and A/R aging reports for bank clients. The webpage 2900 can be customized as needed with greater or fewer links to these and other reports. Reports can be formatted in a suitable application program format prior to viewing by a user. Fewer or greater reports providing transaction-related information can exist on a webpage depending on the customer, and further according to other embodiments of the invention.

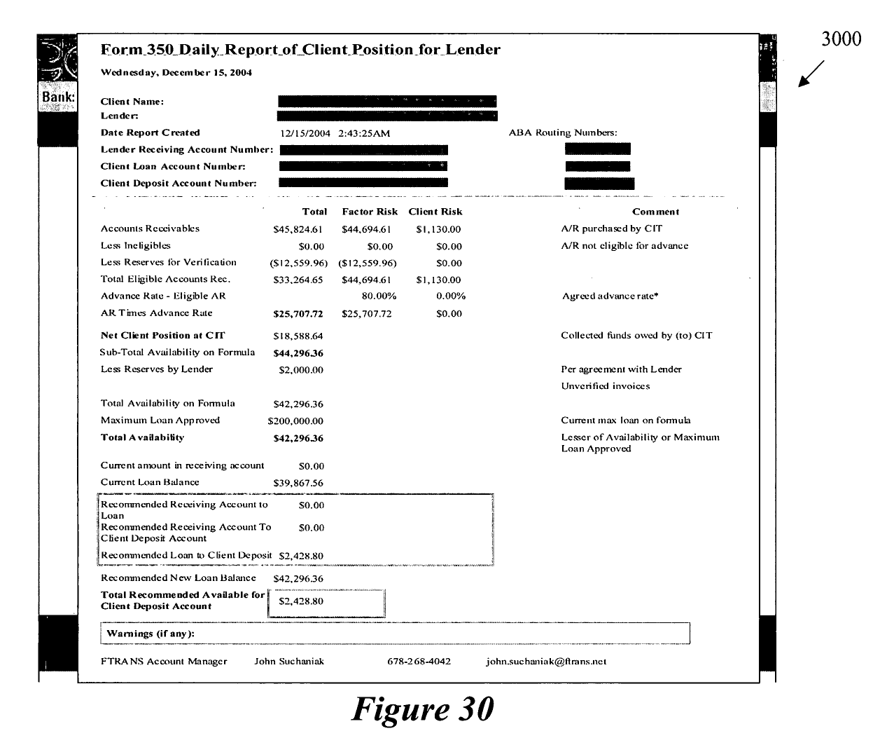

In FIG. 30, a webpage with reporting-type functionality is illustrated. As shown in FIG. 30, a form 350 daily report webpage 3000 can display a report of a daily report of a seller or client position for a user such as a seller sponsor or bank to view. In the example shown in FIG. 30, a form 350 daily report can include, but is not limited to, a client or seller name, lender or seller sponsor name, date report created, ABA routing numbers, lender receiving account number, client loan account number, client deposit account number, account receivables and associated account receivable data, advance rates, net client position, total availability, current loan balance, recommended receiving amount to loan, recommended receiving amount to client deposit account, and recommended loan to client deposit, recommended loan balance, total recommended available for client deposit account, and warnings (if any). Some or all of the reporting information can exist on a webpage depending on the number of search results and further according to other embodiments of the invention.

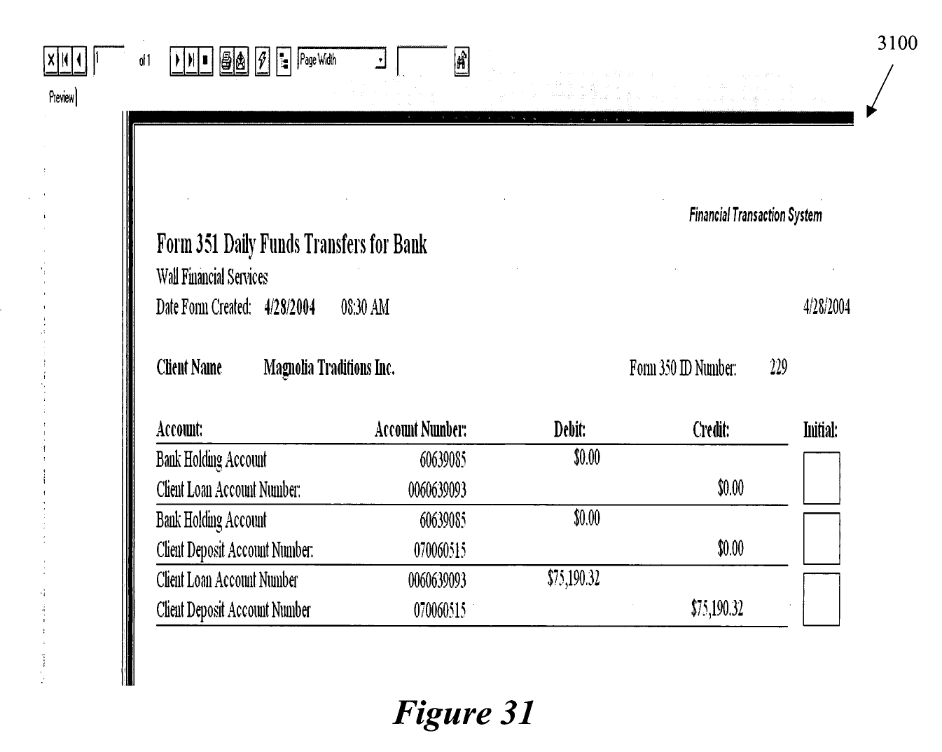

In FIG. 31, a webpage with reporting-type functionality is illustrated. As shown in FIG. 31, a form 351 daily fund transfers report webpage 3100 can display a report daily fund transfers for a user such as a seller sponsor to view. In the example shown in FIG. 31, a form 351 daily fund transfers report can include, but is not limited to, account information such as for a bank holding account and/or client loan account, account numbers, debits, credits, and initials of a user or other reviewer. Some or all of the reporting information can exist on a webpage according to other embodiments of the invention.

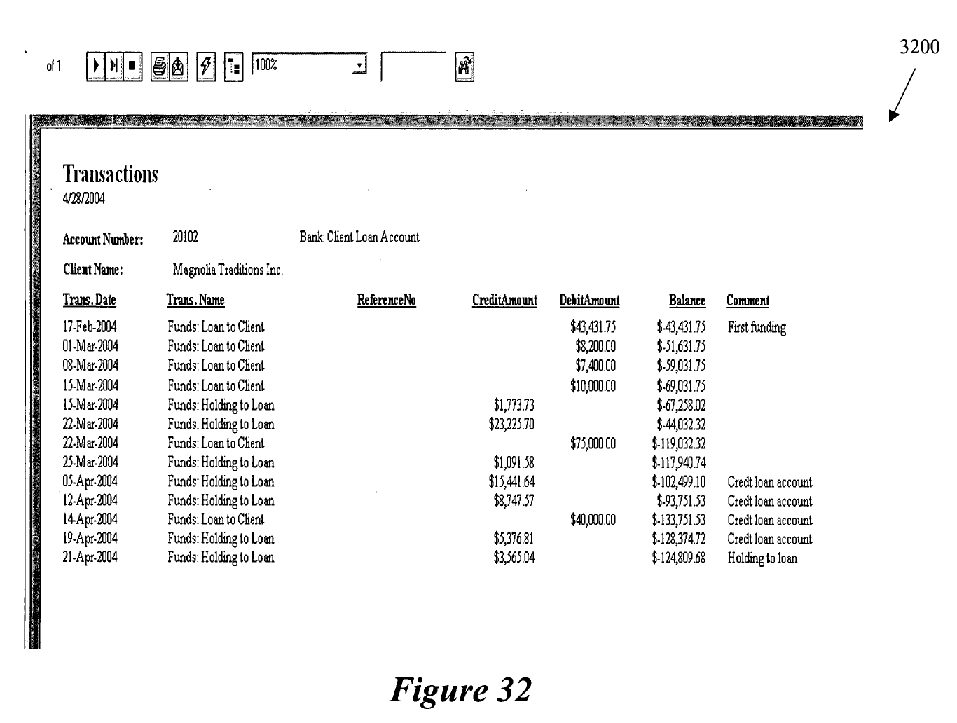

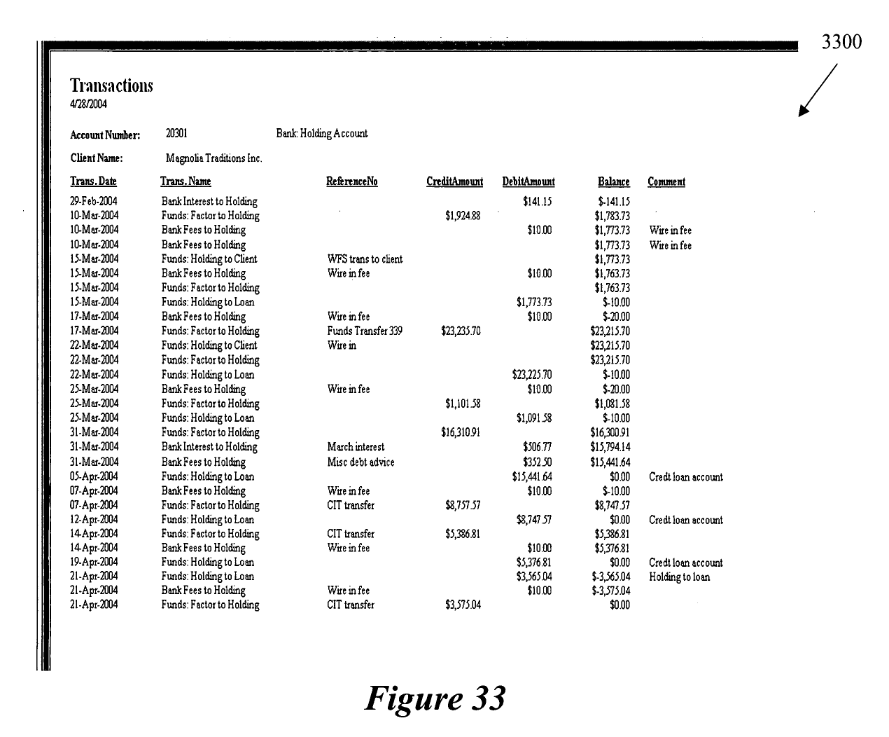

In FIGS. 32 and 33, webpages with reporting-type functionality are illustrated. As shown in FIGS. 32 and 33, detail view report webpages 3200, 3300 can display individual account for a user such as a seller sponsor to view. In the examples shown in FIGS. 32 and 33, detail view reports can include double entry accounting entries for various transactions. Some or all of the reporting information can exist on a webpage according to other embodiments of the invention.

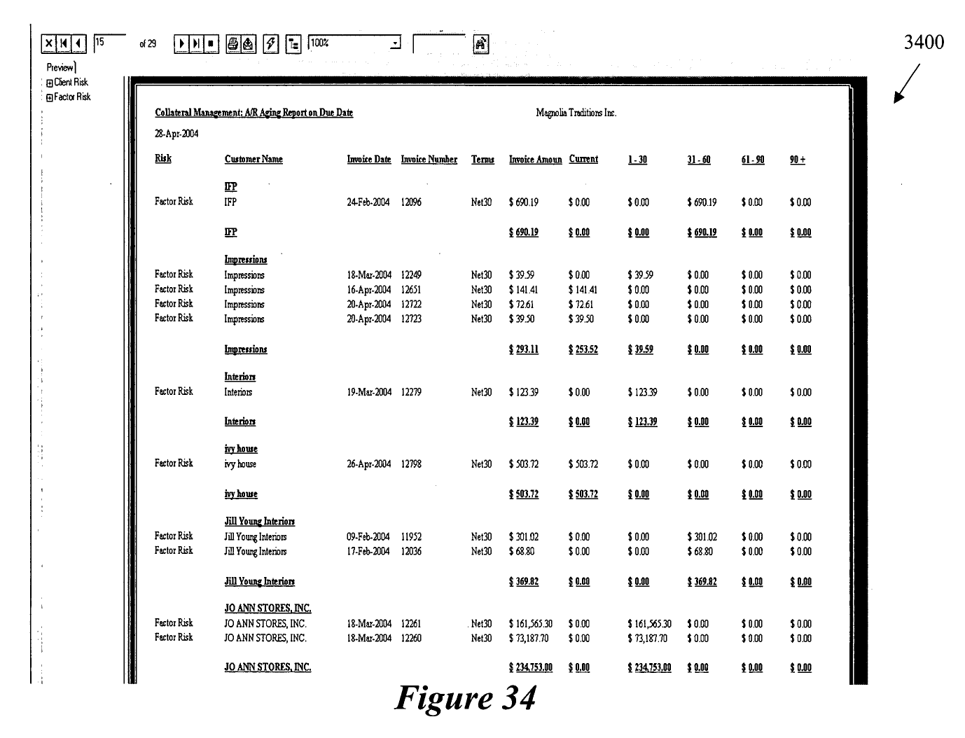

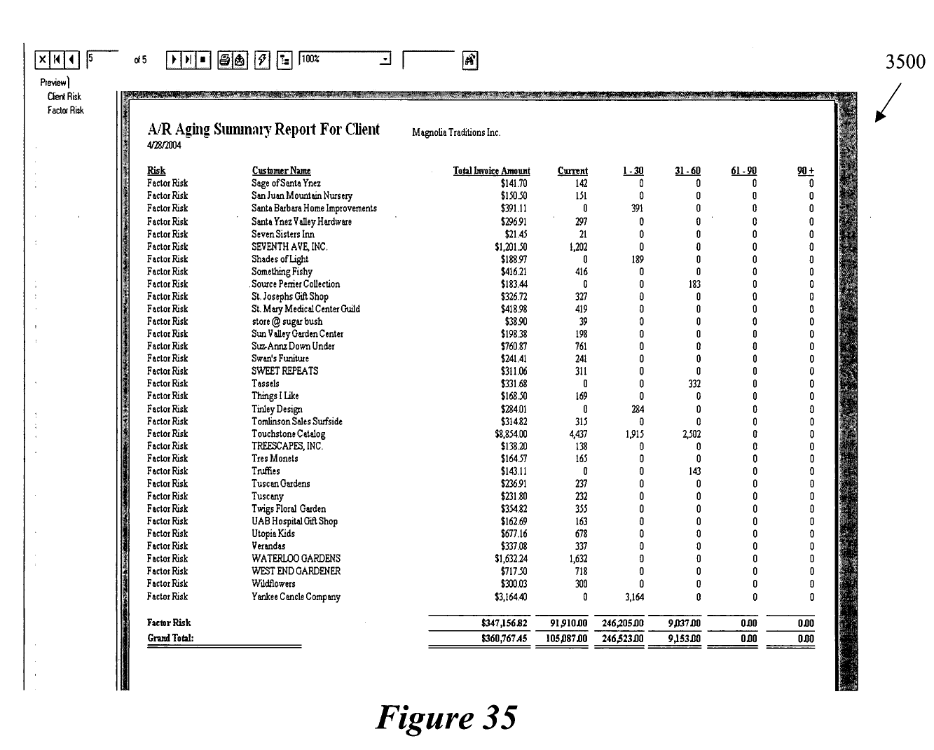

In FIGS. 34 and 35, webpages with reporting-type functionality are illustrated. As shown in FIGS. 34 and 35, aging account receivable report webpages 3400, 3500 can display aging account receivables for a user such as a seller sponsor to view. In the examples shown in FIG. 34 and 35, aging account receivable reports can include account receivable entries and related data for various transactions. Some or all of the reporting information can exist on a webpage according to other embodiments of the invention.

FIG. 36 illustrates an examples of screenshots for a financial transaction website interface for a user, such as a user associated with a customer sponsor, bank, or other financial institution. In this example, a screenshot of a website 3600 with original data from a customer sponsor is illustrated. In at least one embodiment, a user 210a associated with a seller sponsor can access the website 3600 or data associated with the website 3600 via the network 214. In the website 3600 shown, data from a customer sponsor can include, but is not limited to, date, item description, receivables, client position, funds in use, date, and other transaction-related data. Some or all of the data can exist on a webpage according to other embodiments of the invention.

Other screenshots or user interfaces can be implemented or otherwise facilitated by an automated trade credit processing application engine in accordance with other embodiments of the invention. The above examples are intended to be by way of example, and are not intended to limit the scope of the invention.

While the above description contains many specifics, these specifics should not be construed as limitations on the scope of the invention, but merely as exemplifications of the disclosed embodiments. Those skilled in the art will envision any other possible variations that are within the scope of the invention.

The invention claimed is:

1. A computer-implemented method for automating processing of a trade credit transaction between a seller and a customer, comprising:
providing an automated trade credit transaction processing program on a computer system capable of:
approving a customer for a purchase using trade credit;
causing an invoice associated with the purchase to be assigned to a customer sponsor;
determining an advance for a seller sponsor to pay to a seller associated with the purchase, wherein the customer sponsor can guarantee payment of some or all of the invoice to the seller sponsor; and
after a customer sponsor makes a payment against the invoice to the seller sponsor, determining an allocation for the payment, wherein the allocation can be applied by the seller sponsor to an account associated with the seller.

2. The method of claim 1, wherein approving a customer for a purchase using trade credit comprises accessing a database comprising credit related data.

3. The method of claim 1, wherein causing an invoice associated with the purchase to be assigned to a customer sponsor comprises receiving an electronic invoice from the seller and transmitting the electronic invoice to the customer sponsor.

4. The method of claim 1, wherein determining an advance for a seller sponsor to pay to a seller associated with the purchase comprises applying at least one fraud detection rule to information associated with the purchase, and if fraudulent activity is detected, notifying the seller sponsor of the fraudulent activity.

5. The method of claim 1, wherein determining an advance for a seller sponsor to pay to a seller associated with the purchase comprises applying at least one credit rule to information associated with the purchase, and the advance is based in part on collateral associated with the seller.

6. The method of claim 5, wherein the at least one credit rule can be obtained from the seller sponsor.

7. The method of claim 1, wherein determining an allocation for the payment comprises applying at least one lending rule to determine the allocation, wherein the allocation can be applied to either a loan account or deposit account.

8. The method of claim 7, wherein the at least one lending rule can be obtained from the seller sponsor.

9. The method of claim 1, wherein the seller comprises at least one of the following: a business, or a government.

10. The method of claim 1, wherein the customer comprises at least one of the following: a business, or a government.

11. The method of claim 1, wherein the customer sponsor comprises at least one of the following: a bank, a savings and loan, or a financial institution.

12. The method of claim 1, wherein the seller sponsor comprises at least one of the following: a bank, a savings and loan, or a financial institution.

13. The method of claim 1, further comprising:
providing a user interface with a double accounting entry format to display at least one of the following: an advance, a payment, an amount associated with an invoice, or an allocation.

14. The method of claim 13, wherein the user interface is capable of displaying data associated with at least one transaction from an individual point of view of at least one of the following: a buyer, a seller, a seller sponsor, or customer sponsor.

15. A computer-implemented method for using trade credit to facilitate a purchase for a customer, comprising:
providing an automated trade credit transaction processing program on a computer system capable of:
requesting approval of a purchase using trade credit;
receiving approval or denial of the purchase using trade credit;
assigning an invoice associated with the purchase to a customer sponsor, wherein the customer sponsor can guarantee payment of some or all of the invoice to a seller sponsor, and the customer sponsor can receive a payment from the customer for the purchase; and
receiving an advance from a seller sponsor for the purchase.

16. The method of claim 15, wherein requesting approval of a purchase using trade credit comprises providing a trade credit account number associated with the customer.

17. The method of claim 15, wherein receiving approval of the purchase comprises providing a good or service associated with the purchase to the customer.

18. The method of claim 15, wherein assigning an invoice associated with the purchase to a customer sponsor comprises transmitting an electronic invoice to the customer sponsor.

19. The method of claim 15, wherein receiving an advance from a seller sponsor for the purchase comprises paying interest on the advance to the seller sponsor, wherein the interest is predetermined by the seller sponsor.

20. The method of claim 15, wherein the customer comprises at least one of the following: a business, or a government.

21. The method of claim 15, wherein the customer sponsor comprises at least one of the following: a bank, a savings and loan, or a financial institution.

22. The method of claim 15, wherein the seller sponsor comprises at least one of the following: a bank, a savings and loan, or a financial institution.

23. The method of claim 15, further comprising:
providing a user interface with a double accounting entry format to display at least one of the following: an advance, a payment, an amount associated with an invoice, or an allocation.

24. The method of claim 23, wherein the user interface is capable of displaying data associated with at least one transaction from an individual point of view of at least one of the following: a buyer, a seller, a seller sponsor, or customer sponsor.

25. A computer-implemented method for using trade credit to facilitate a purchase from a seller, comprising:
providing an automated trade credit transaction processing program on a computer system capable of:
requesting a trade credit transaction from a seller;
receiving a good or service in a purchase associated with the trade credit transaction;
receiving a notification from a customer sponsor to pay for the purchase, wherein the customer sponsor can be assigned an invoice associated with the purchase, and the customer sponsor can guarantee a payment of the invoice to a seller sponsor; and
transmitting a payment for the purchase to the customer sponsor.

26. The method of claim 25, wherein requesting a trade credit transaction from a seller comprises providing a trade credit account number to the seller, and receiving approval of the trade credit transaction.

27. The method of claim 25, wherein a notification comprises at least one of the following: an amount of payment, an installment amount, due date or time, a payment instruction, a type of monetary instrument required for payment, and an account number for payment deposit or transfer

28. The method of claim 25, wherein transmitting a payment for the purchase to the customer sponsor comprises paying some or all of a price associated with the purchase from the seller.

29. The method of claim 25, wherein the seller comprises at least one of the following: a business, or a government.

30. The method of claim 25, wherein the customer sponsor comprises at least one of the following: a bank, a savings and loan, or a financial institution.

31. The method of claim 25, wherein the seller sponsor comprises at least one of the following: a bank, a savings and loan, or a financial institution.

32. The method of claim 25, further comprising:
providing a user interface with a double accounting entry format to display at least one of the following: an advance, a payment, an amount associated with an invoice, or an allocation.

33. The method of claim 32, wherein the user interface is capable of displaying data associated with at least one transaction from an individual point of view of at least one of the following: a buyer, a seller, a seller sponsor, or customer sponsor.

34. A computer-implemented method for processing a trade credit transaction, comprising:
providing an automated trade credit transaction processing program on a computer system capable of:
receiving assignment of an invoice associated with a purchase made by a customer using trade credit, wherein payment of the invoice is guaranteed to a seller sponsor;
notifying the customer of a payment term associated with the purchase; and
paying a seller sponsor some or all of an amount associated with the invoice.

35. The method of claim 34, further comprising:
receiving a payment associated with the purchase from the customer.

36. The method of claim 34, wherein receiving assignment of an invoice associated with a purchase made by a customer using trade credit comprises receiving an electronic invoice from a seller.

37. The method of claim 34, wherein a payment term comprises at least one of the following: an amount of payment, an installment amount, due date or time, a payment instruction, a type of monetary instrument required for payment, and an account number for payment deposit or transfer.

38. The method of claim 34, wherein paying a seller sponsor some or all of an amount associated with the invoice comprises transmitting a payment to the seller sponsor and settling the invoice with the seller sponsor.

39. The method of claim 34, further comprising:
receiving a fee from the customer based at least on one of the following: an amount associated with the invoice, or volume of purchases using trade credit over a period.

40. The method of claim 34, further comprising:
providing a user interface with a double accounting entry format to display at least one of the following: an advance, a payment, an amount associated with an invoice, or an allocation.

41. The method of claim 40, wherein the user interface is capable of displaying data associated with at least one transaction from an individual point of view of at least one of the following: a buyer, a seller, a seller sponsor, or customer sponsor.

42. A computer-implemented method for processing a trade credit transaction, comprising:
providing an automated trade credit transaction processing program on a computer system capable of:
paying an advance to a seller, wherein the advance is associated with a purchase from the seller;
receiving a payment from a customer sponsor, wherein the payment is associated with an invoice assigned to the customer sponsor by the seller; and
allocating the payment to at least one account associated with the seller.

43. The method of claim 42, wherein paying an advance to a seller comprises paying funds to an account associated with the seller.

44. The method of claim 42, wherein paying an advance to a seller comprises determining a payment amount based on at least one credit rule associated with the seller sponsor.

45. The method of claim 44, wherein determining a payment amount based on at least one credit rule associated with the seller sponsor can be facilitated by a third party.

46. The method of claim 44, wherein the at least one credit rule comprises at least one of the following: a rule, a flowchart, an algorithm, a matrix, a decision tool, or a strategy.

47. The method of claim 42, wherein receiving a payment from a customer sponsor comprises receiving some or all of an amount associated with the invoice.

48. The method of claim 42, wherein allocating the payment to at least one account associated with the seller comprises allocating the payment between at least a loan account and a deposit account.

49. The method of claim 42, wherein allocating the payment to at least one account associated with the seller comprises determining an allocation based on at least one lending rule associated with the seller sponsor.

50. The method of claim 49, wherein determining an allocation based on at least one lending rule associated with the seller sponsor can be facilitated by a third party.

51. The method of claim 49, wherein the at least one lending rule comprises at least one of the following: a rule, a flowchart, an algorithm, a matrix, a decision tool, or a strategy.

52. The method of claim 42, further comprising:
determining a fee based at least on the advance, wherein the fee can be paid by the seller.

53. The method of claim 42, further comprising:
providing a user interface with a double accounting entry format to display at least one of the following: an advance, a payment, an amount associated with an invoice, or an allocation.

54. The method of claim 53, wherein the user interface is capable of displaying data associated with at least one transaction from an individual point of view of at least one of the following: a buyer, a seller, a seller sponsor, or customer sponsor.

55. A system for automating processing of a trade credit transaction between a seller and a customer, comprising:
an automated trade credit processing application engine adapted to:
approve a customer for a purchase using trade credit;
cause an invoice associated with the purchase to be assigned to a customer sponsor;
determine an advance for a seller sponsor to pay to a seller associated with the purchase, wherein the customer sponsor can guarantee payment of some or all of the invoice to the seller sponsor; and
after a customer sponsor makes a payment against the invoice to the seller sponsor, determine an allocation for the payment, wherein the allocation can be applied by the seller sponsor to an account associated with the seller.

56. The system of claim 55, wherein to approve a customer for a purchase using trade credit comprises accessing a database comprising credit related data.

57. The system of claim 55, wherein to cause an invoice associated with the purchase to be assigned to a customer sponsor comprises receiving an electronic invoice from the seller and transmitting the electronic invoice to the customer sponsor.

58. The system of claim 55, wherein to determine an advance for a seller sponsor to pay to a seller associated with the purchase comprises applying at least one fraud detection rule to information associated with the purchase, and if fraudulent activity is detected, notifying the seller sponsor of the fraudulent activity.

59. The system of claim 55, wherein to determine an advance for a seller sponsor to pay to a seller associated with the purchase comprises applying at least one credit rule to information associated with the purchase, and the advance is based in part on collateral associated with the seller.

60. The system of claim 59, wherein the at least one credit rule can be obtained from the seller sponsor.

61. The system of claim 55, wherein to determine an allocation for the payment comprises applying at least one lending rule to determine the allocation, wherein the allocation can be applied to either a loan account or deposit account.

62. The system of claim 61, wherein the at least one lending rule can be obtained from the seller sponsor.

63. The system of claim 55, wherein the seller comprises at least one of the following: a business, or a government.

64. The system of claim 55, wherein the customer comprises at least one of the following: a business, or a government.

65. The system of claim 55, wherein the customer sponsor comprises at least one of the following: a bank, a savings and loan, or a financial institution.

66. The system of claim 55, wherein the seller sponsor comprises at least one of the following: a bank, a savings and loan, or a financial institution.

67. The system of claim 55, wherein the automated trade credit processing application engine is further adapted to:
provide a user interface with a double accounting entry format to display at least one of the following: an advance, a payment, an amount associated with an invoice, or an allocation.

68. The system of claim 67, wherein the user interface is capable of displaying data associated with at least one transaction from an individual point of view of at least one of the following: a buyer, a seller, a seller sponsor, or customer sponsor.

69. A computer system for using trade credit to facilitate a purchase for a customer, comprising:
an automated trade credit processing application engine adapted to:
request approval of a purchase using trade credit;
receive approval or denial of the purchase using trade credit;
assign an invoice associated with the purchase to a customer sponsor, wherein the customer sponsor can guarantee payment of some or all of the invoice to a seller sponsor, and the customer sponsor can receive a payment from the customer for the purchase; and
receive an advance from a seller sponsor for the purchase.

70. The system of claim 69, wherein to request approval of a purchase using trade credit comprises providing a trade credit account number associated with the customer.

71. The system of claim 69, wherein to receive approval of the purchase comprises providing a good, service, or intangible associated with the purchase to the customer.

72. The system of claim 69, wherein to assign an invoice associated with the purchase to a customer sponsor comprises transmitting an electronic invoice to the customer sponsor.

73. The system of claim 69, wherein to receive an advance from a seller sponsor for the purchase comprises paying interest on the advance to the seller sponsor, wherein the interest is predetermined by the seller sponsor.

74. The system of claim 69, wherein the customer comprises at least one of the following: a business, or a government.

75. The system of claim 69, wherein the customer sponsor comprises at least one of the following: a bank, a savings and loan, or a financial institution.

76. The system of claim 69, wherein the seller sponsor comprises at least one of the following: a bank, a savings and loan, or a financial institution.

77. The system of claim 69, wherein the automated trade credit processing application engine is further adapted to:
provide a user interface with a double accounting entry format to display at least one of the following: an advance, a payment, an amount associated with an invoice, or an allocation.

78. The system of claim 77, wherein the user interface is capable of displaying data associated with at least one transaction from an individual point of view of at least one of the following: a buyer, a seller, a seller sponsor, or customer sponsor.

79. A computer system for using trade credit to facilitate a purchase from a seller, comprising:
an automated trade credit processing application engine adapted to:
request a trade credit transaction from a seller;
receive a good or service in a purchase associated with the trade credit transaction;
receive a notification from a customer sponsor to pay for the purchase, wherein the customer sponsor can be assigned an invoice associated with the purchase, and the customer sponsor can guarantee a payment of the invoice to a seller sponsor; and
transmit a payment for the purchase to the customer sponsor.

80. The system of claim 79, wherein to request a trade credit transaction from a seller comprises providing a trade credit account number to the seller, and receiving approval of the trade credit transaction.

81. The system of claim 79, wherein a notification comprises at least one of the following: an amount of payment, an installment amount, due date or time, a payment instruction, a type of monetary instrument required for payment, or an account number for payment deposit or transfer.

82. The system of claim 79, wherein to transmit a payment for the purchase to the customer sponsor comprises paying some or all of a price associated with the purchase from the seller.

83. The system of claim 79, wherein the seller comprises at least one of the following: a business, or a government.

84. The system of claim 79, wherein the customer sponsor comprises at least one of the following: a bank, a savings and loan, or a financial institution.

85. The system of claim 79, wherein the seller sponsor comprises at least one of the following: a bank, a savings and loan, or a financial institution.

86. The system of claim 79, wherein the automated trade credit processing application engine is further adapted to:
provide a user interface with a double accounting entry format to display at least one of the following: an advance, a payment, an amount associated with an invoice, or an allocation.

87. The system of claim 86, wherein the user interface is capable of displaying data associated with at least one transaction from an individual point of view of at least one of the following: a buyer, a seller, a seller sponsor, or customer sponsor.

88. A computer system for processing a trade credit transaction, comprising:
an automated trade credit processing application engine adapted to:
receive assignment of an invoice associated with a purchase made by a customer using trade credit, wherein payment of the invoice is guaranteed to a seller sponsor;
notify the customer of a payment term associated with the purchase; and
pay a seller sponsor some or all of an amount associated with the invoice.

89. The system of claim 88, wherein the automated trade credit processing application engine is further adapted to:
receive a payment associated with the purchase from the customer.

90. The system of claim 88, wherein to receive assignment of an invoice associated with a purchase made by a customer using trade credit comprises receiving an electronic invoice from a seller.

91. The system of claim 88, wherein a payment term comprises at least one of the following: an amount of payment, an installment amount, due date or time, a payment instruction, a type of monetary instrument required for payment, or an account number for payment deposit or transfer.

92. The system of claim 88, wherein to pay a seller sponsor some or all of an amount associated with the invoice comprises transmitting a payment to the seller sponsor and settling the invoice with the seller sponsor.

93. The system of claim 88, wherein the automated trade credit processing application engine is further adapted to:
receive a fee from the customer based at least on one of the following: an amount associated with the invoice, or volume of purchases using trade credit over a period.

94. The system of claim 88, wherein the automated trade credit processing application engine is further adapted to:
provide a user interface with a double accounting entry format to display at least one of the following: an advance, a payment, an amount associated with an invoice, or an allocation.

95. The system of claim 94, wherein the user interface is capable of displaying data associated with at least one transaction from an individual point of view of at least one of the following: a buyer, a seller, a seller sponsor, or customer sponsor.

96. A computer system for processing a trade credit transaction, comprising:
an automated trade credit processing application engine adapted to:
pay an advance to a seller, wherein the advance is associated with a purchase from the seller;
receive a payment from a customer sponsor, wherein the payment is associated with an invoice assigned to the customer sponsor by the seller; and
allocate the payment to at least one account associated with the seller.

97. The system of claim 96, wherein to pay an advance to a seller comprises paying funds to an account associated with the seller.

98. The system of claim 96, wherein to pay an advance to a seller comprises determining a payment amount based on at least one credit rule associated with the seller sponsor.

99. The system of claim 96, wherein to determine a payment amount based on at least one credit rule associated with the seller sponsor can be facilitated by a third party.

100. The system of claim 99, wherein the at least one credit rule comprises at least one of the following: a rule, a flowchart, an algorithm, a matrix, a decision tool, or a strategy.

101. The system of claim 96, wherein to receive a payment from a customer sponsor comprises receiving some or all of an amount associated with the invoice.

102. The system of claim 96, wherein to allocate the payment to at least one account associated with the seller comprises allocating the payment between at least a loan account and a deposit account.

103. The system of claim 96, wherein to allocate the payment to at least one account associated with the seller comprises determining an allocation based on at least one lending rule associated with the seller sponsor.

104. The system of claim 103, wherein determining an allocation based on at least one lending rule associated with the seller sponsor can be facilitated by a third party.

105. The system of claim 104, wherein the at least one lending rule comprises at least one of the following: a rule, a flowchart, an algorithm, a matrix, a decision tool, or a strategy.

106. The system of claim 96, wherein the automated trade credit processing application engine is further adapted to:
determine a fee based at least on the advance, wherein the fee can be paid by the seller.

107. The system of claim 96, wherein the automated trade credit processing application engine is further adapted to:
provide a user interface with a double accounting entry format to display at least one of the following: an advance, a payment, an amount associated with an invoice, or an allocation.

108. The system of claim 107, wherein the user interface is capable of displaying data associated with at least one transaction from an individual point of view of at least one of the following: a buyer, a seller, a seller sponsor, or customer sponsor.
